(19) United States
(12) Patent Application Publication
(10) Pub. No.: US 2023/0134564 A1
(43) Pub. Date: May 4, 2023

(54) FOLDABLE ELECTRONIC DEVICE AND METHOD FOR OPERATING THE SAME

(71) Applicant: SAMSUNG ELECTRONICS CO., LTD., Suwon-si (KR)

(72) Inventors: Hongjun KIM, Suwon-si (KR); Jiwon Jang, Suwon-si (KR); Myunghun Bae, Suwon-si (KR)

(21) Appl. No.: 17/713,156

(22) Filed: Apr. 4, 2022

Related U.S. Application Data
(63) Continuation of application No. PCT/KR2022/002825, filed on Feb. 25, 2022.

(30) Foreign Application Priority Data
Oct. 28, 2021 (KR) 10-2021-0145823

(51) Int. Cl. H05K 5/02; H05K 5/00

(52) U.S. Cl. CPC H05K 5/0226; H05K 5/0018

(57) ABSTRACT

A foldable electronic device includes a foldable enclosure including a plurality of sub-enclosures, a hinge coupled to ends of the plurality of sub-enclosures to interconnect the sub-enclosures and to allow the foldable enclosure to be folded or unfolded by rotation of the sub-enclosures, a biaser to apply a rotational force to the hinge in a direction that causes the foldable enclosure to be unfolded, a follower located inside any one of the sub-enclosures and supported for incremental movement during folding or unfolding of the foldable enclosure, a stop to selectively come into contact with or be separated from the follower to selectively restrict the movement of the follower, and an actuator to selectively control folding and unfolding of the foldable electronic device by selectively causing the stop to come into contact with or be separated from the follower.

### CROSS REFERENCE TO RELATED APPLICATION

This application is a Bypass Continuation of International Patent Application No. PCT/KR2022/002825, filed on Feb. 25, 2022, which claims priority from and the benefit of Korean Patent Application No. 10-2021-0145823, filed on Oct. 28, 2021, which is hereby incorporated by reference for all purposes as if fully set forth herein.

### BACKGROUND

### Field

Illustrative embodiments of the invention relate generally to electronic devices, and more specifically, to a foldable electronic device and method for operating the same.

### Discussion of the Background

Electronic devices typically require a small profile for portability and require a large display area to provide much information to a user. In order to make a small profile compatible with a large display area in an electronic device, various form factors as in a foldable electronic device equipped with a flexible display are being used in addition to the known elongated rectangular form factor. An electronic device having a foldable form factor may include a foldable housing configured to be folded or unfolded around at least one hinge part to fold or unfold a flexible display. For various uses of a foldable electronic device, a hinge part of a foldable housing may include a detent hinge or a free stop hinge that has resistance to rotation.

The above information disclosed in this Background section is only for understanding of the background of the inventive concepts, and, therefore, it may contain information that does not constitute prior art.

### SUMMARY

Applicant recognized that when the foldable electronic devices are folded or unfolded by a user, the resistance of the hinge part may make it difficult and/or uncomfortable for the user to open (unfold). For example, when the foldable electronic device is unfolded, the foldable display may be pressed by the user's hand, resulting in permanent a dent or damage to the sensitive electronic panel of the foldable display. In addition, in order to open and use the foldable electronic device, it is necessary to separately perform the operation of unfolding the foldable electronic device and the operation of unlocking the foldable electronic device, which may reduce the user's convenience. Moreover, designing a hinge structure that facilitates opening and closing of a foldable display without requiring too much force or discomfort and which can be opened to any desired angle, but is not cumbersome and does not take up too much space is difficult to achieve, especially in electronic devices having smaller form factors, like mobile phones.

Foldable electronic devices constructed according to the principles and implementations of the invention allow the device to be unfolded and opened automatically only by one touch of a button without making it inconvenient or difficult for the user to open and close foldable part or adjust it to an arbitrary angle, while at the same time allowing adjustment to an arbitrary angle required by the user without consuming additional space, such as by designing the opening button to be used in common with other functions, (e.g., a power button). For example, embodiments of the foldable electronic device may include a biaser that drives a hinge based on the release of a stop interlocked with an actuator so that the foldable electronic device is automatically unfolded by pushing the actuator. Moreover, since the actuator may include an electrical switch, the foldable electronic device may perform not only a haptic operation but also an unlocking operation interlocked with the unfolding operation when the switch is pushed.

Foldable electronic devices constructed according to the principles and embodiments of the invention provide improved user operability and convenience during folding and unfolding operations, while avoiding risk of damage to the sensitive display and other components, which may be achieved in a compact electronic device, such as a mobile phone.

Additional features of the inventive concepts will be set forth in the description which follows, and in part will be apparent from the description, or may be learned by practice of the inventive concepts.

According to one aspect of the invention, a foldable electronic device includes a foldable enclosure including a plurality of sub-enclosures, a hinge coupled to ends of the plurality of sub-enclosures to interconnect the sub-enclosures and to allow the foldable enclosure to be folded or unfolded by rotation of the sub-enclosures, a biaser to apply a rotational force to the hinge in a direction that causes the foldable enclosure to be unfolded, a follower located inside any one of the sub-enclosures and supported for incremental movement during folding or unfolding of the foldable enclosure, a stop to selectively come into contact with or be separated from the follower to selectively restrict the movement of the follower, and an actuator to selectively control folding and unfolding of the foldable electronic device by selectively causing the stop to come into contact with or be separated from the follower.

At least one the following may apply: the foldable enclosure may include a foldable housing and the foldable sub-enclosures may include foldable sub-housings; the hinge may include a hinge part; the biaser may include an elastic member; the follower may include an interlocking part; the stop may include a motion restriction member; and the actuator may include a button part. The follower may include a ratchet wheel supported for rotation conjunction with the hinge and including a plurality of teeth, and the stop may include a ratchet pawl selectively engageable with the teeth of the ratchet wheel.

The follower may include a brake rotor supported for rotation with the hinge, and the stop may include a brake shoe selectively engageable against the brake rotor to restrict rotation of the brake rotor at an arbitrary rotation angle by friction. The brake shoe and the brake rotor may be slid relative to each other when an external force for folding or unfolding the foldable housing is applied in response to the actuator not being actuated, thereby allowing the foldable electronic device to be folded or unfolded. The brake rotor may have a truncated cone shape, and may include a brake drum having a first friction surface formed on a side surface of the truncated cone shape, and the brake shoe may include a second friction surface having a shape corresponding to the first friction surface.

The follower may include a movable member supported for incremental movement relative to the sub-enclosures in response to folding or unfolding of the foldable housing. The movable member may include a sliding member having a rack in which a plurality of teeth are arranged linearly, the follower may include a pinion gear engageable with the rack to rotate incrementally with a linear movement of the rack, and a brake rotor supported for rotation by being coupled to the pinion gear, and the stop may include a brake shoe selectively engageable against the brake rotor to restrict the rotation of the brake rotor at an arbitrary rotation angle by friction.

The movable member may include a sliding friction surface disposed parallel to the sliding direction, and the stop may include a linear brake configured to apply a frictional force to the sliding friction surface by being engaged against the sliding friction surface. The movable member may further include a first brake pad attached to the sliding friction surface, and the stop may further include a second brake pad attached to a surface of the linear brake facing the sliding friction surface. The movable member may further include a first irregularity formed on the sliding friction surface, and the stop may include a second irregularity formed on a surface of the linear brake facing the sliding friction surface. Frictional force between the follower and the stop may have a relatively large value with respect to a direction in which the movable member is supported for movement when the foldable enclosure is unfolded, and may have a relatively small value with respect a direction in which the movable member is supported for movement when the foldable enclosure is folded. The first irregularity and the second irregularity may include asymmetric irregularities that have a relatively steep slope with respect to a direction in which the movable member is supported for linear movement when the foldable enclosure is unfolded, and may have a relatively gentle slope with respect to a direction in which the movable member is supported for linear movement when the foldable housing is folded.

The movable member may further include a plurality of second sliding friction surfaces opposed to each other, and the stop may further include a clamp to apply a frictional force by holding the movable member on the plurality of second sliding friction surfaces. The foldable electronic device may further include a clamp housing including an inner space into which at least a portion of the clamp is inserted, wherein the clamp may include an inclined surface in contact with the inner surface of the inner space of the clamp housing, and the inclined surface may press the clamp against the second sliding friction surfaces by being moved while being in contact with the inner surface of the inner space of the clamp when the clamp is inserted into the clamp housing. The movable member may further include an expansion portion in which a thickness of the movable member is gradually increased, the clamp may further include a curved portion provided at a distal end facing the expansion portion, and when the clamp is moved toward the expansion portion, the curved portion may be moved along a surface of the expansion portion so that the clamp is spaced apart from the second sliding friction surfaces.

The actuator may include an electrical switch disposed thereon to generate an electrical signal when the actuator is operated. The foldable electronic device may include a sensor to detect the folding or unfolding operation of the foldable housing

According to another aspect of the invention, a method for operating a foldable electronic device having a foldable enclosure, a hinge to allow the foldable enclosure to be folded, a biaser supported for incremental movement during folding or unfolding of the foldable enclosure, a stop to selectively restrict the movement of the follower, an actuator having an electrical switch to control the folding or unfolding operation, and a sensor to detect the folding or unfolding operation includes the steps of: identifying whether or not an electrical signal is generated from the electrical switch; detecting, by the folding sensor, whether or not the foldable housing is being folded or unfolded; and when the electrical switch does not generate the electrical signal and the folding sensor detects a folding or unfolding operation, outputting a warning signal including at least one of a warning sound, a warning vibration, or a warning message display.

The method may further include the step of: when the electrical switch generates the electrical signal and the folding sensor detects folding or unfolding, performing a haptic operation to generate at least one of sound effect playback, haptic vibration, animation playback, and turning-on or off of a display to enhance a user's recognition of the folding or unfolding operation.

The actuator may further includes a fingerprint recognition sensor to generate a fingerprint identification signal with respect to a selected fingerprint, and the method may further include the step of: when the electrical switch generates the electrical signal, the folding sensor detects the folding operation, and the fingerprint recognition sensor generates the fingerprint identification signal, unlocking the foldable housing to permit folding.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram of an embodiment of an electronic device constructed according to the principles of the invention in a network environment.

FIGS. 2A to 2F illustrate an embodiment of a foldable electronic device in the form of a mobile phone having an in-folding type housing structure constructed according to the principles of the invention.

FIG. 3A is a cross-sectional view of a first embodiment of a hinge part of the foldable electronic device of FIGS. 2A to 2F.

FIG. 3B is a cross-sectional view of a first embodiment of an interlocking part and a motion restriction member of the foldable electronic device of FIGS. 2A to 2F.

FIG. 3C is a schematic cross-sectional view illustrating an operation of the interlocking part and the motion restriction member of FIG. 3B.

FIG. 4A is a cross-sectional view of a second embodiment of a hinge part of the foldable electronic device of FIGS. 2A to 2F.

FIG. 4B is an enlarged perspective view of a second embodiment of an interlocking part and a motion restriction member of the foldable electronic device of FIGS. 2A to 2F.

FIG. 4C is a schematic cross-sectional view illustrating an operation of the interlocking part and the motion restriction member of the foldable electronic of FIG. 4B.

FIG. 5A is a cross-sectional view illustrating an operation of a third embodiment of a hinge part of the foldable electronic device of FIGS. 2A to 2F.

FIG. 5B is an enlarged perspective view illustrating the sliding pin of the foldable electronic device of FIG. 5A.

FIG. 5C is a cross-sectional view of a third embodiment of an interlocking part and a motion restriction member of the foldable electronic device of FIGS. 2A to 2F.

FIG. 5D is an enlarged perspective view of the interlocking part and a motion restriction member of FIG. 5C.

FIG. 5E is a schematic cross-sectional view illustrating an operation of the interlocking part and the motion restriction member of FIG. 5D.

FIG. 6A is a cross-sectional view of a fourth embodiment of a hinge part of the foldable electronic device of FIGS. 2A to 2F.

FIG. 6B is an enlarged perspective view of a fourth embodiment of the interlocking part and a motion restriction member of FIG. 6A.

FIG. 6C is a schematic cross-sectional view illustrating an operation of the interlocking part and the motion restriction member of FIG. 6B.

FIG. 6D is a cross-sectional view of a fifth embodiment of a hinge part of the foldable electronic device of FIGS. 2A to 2F.

FIG. 6E is an enlarged perspective view of a fifth embodiment of an interlocking part and a motion restriction member of the foldable electronic device of FIGS. 2A to 2F.

FIGS. 7A to 7D are schematic cross-sectional views of various embodiments of a sliding member and a linear brake of FIGS. 6A to 6E.

FIG. 8A is a cross-sectional view of a sixth embodiment of a hinge part of the foldable electronic device of FIGS. 2A to 2F.

FIG. 8B is an enlarged perspective view of a sixth embodiment of the sliding member and the motion restriction member of FIG. 8A.

FIG. 8C is a schematic cross-sectional view illustrating an operation of the sliding member and the motion restriction member of FIG. 8B.

FIG. 9A is a perspective view of an embodiment of an electrical switch of a button part of the foldable electronic device of FIGS. 2A to 2F.

FIG. 9B is a perspective view of an embodiment of a push button of the foldable electronic device of FIGS. 2A to 2F.

FIG. 9C is a schematic cross-sectional view illustrating an operation of the button part and members of the foldable electronic device of FIGS. 2A to 2F.

FIG. 10 is a flowchart schematically illustrating operations that may occur based on manipulation of the button part shown in FIG. 9C of the foldable electronic device of FIGS. 2A to 2F.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

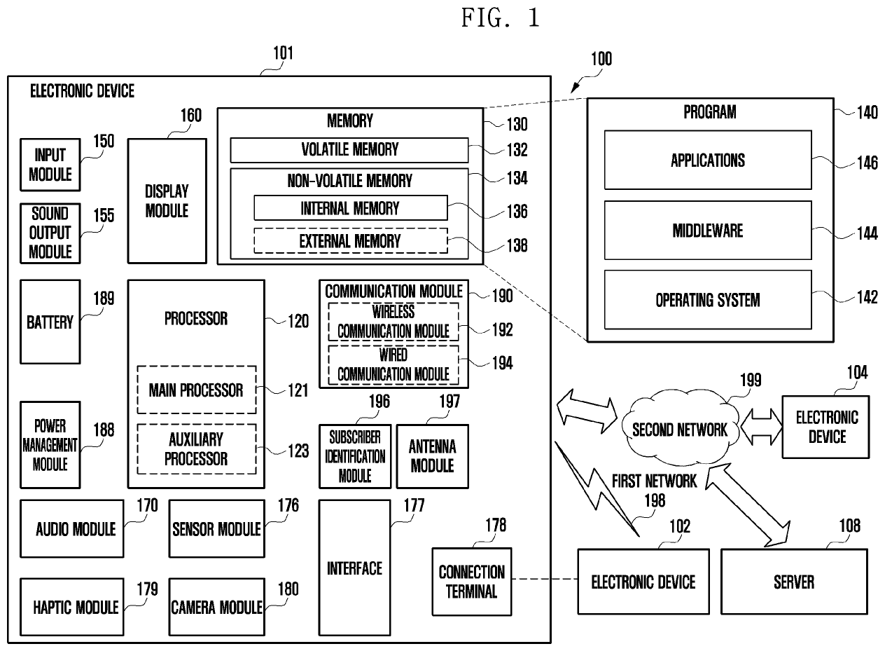

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beamforming, or large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MWC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Playstree^{t}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

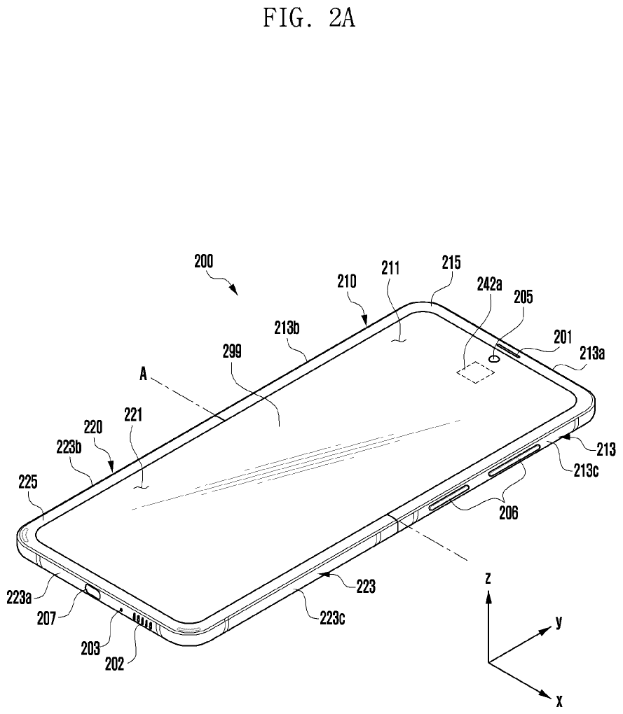

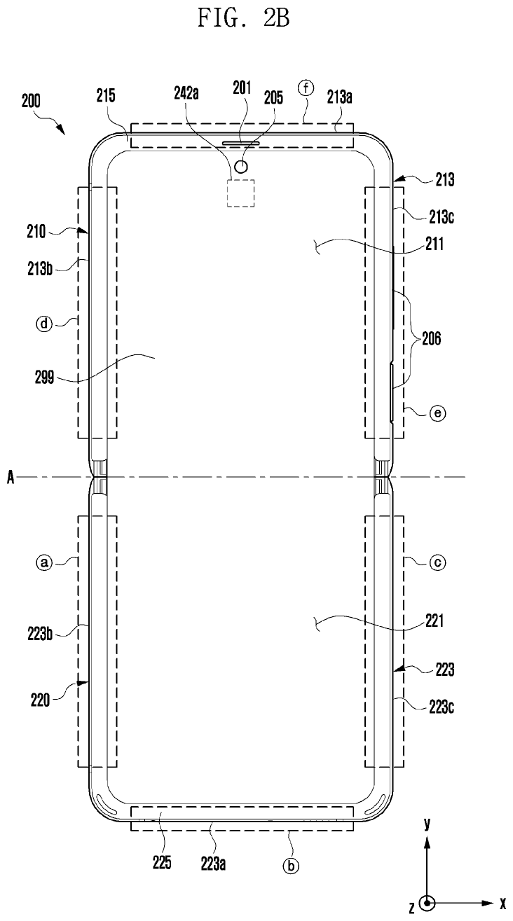

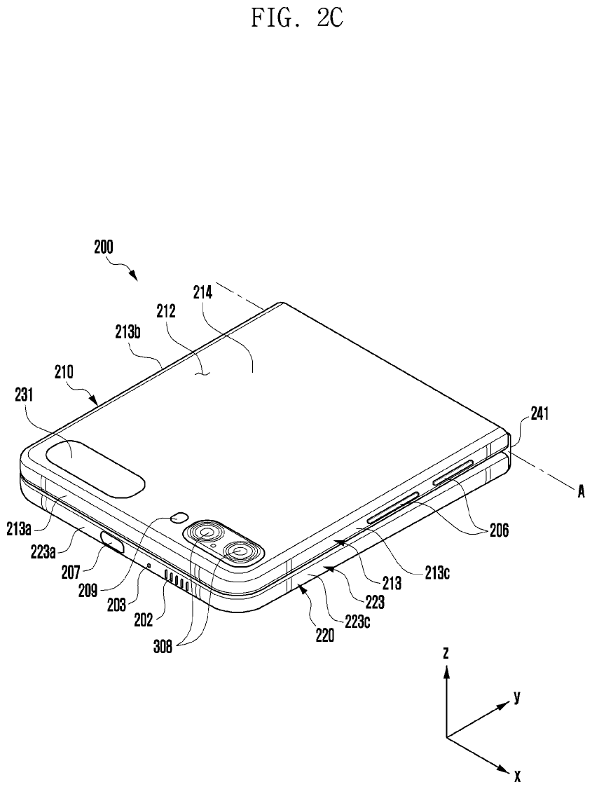

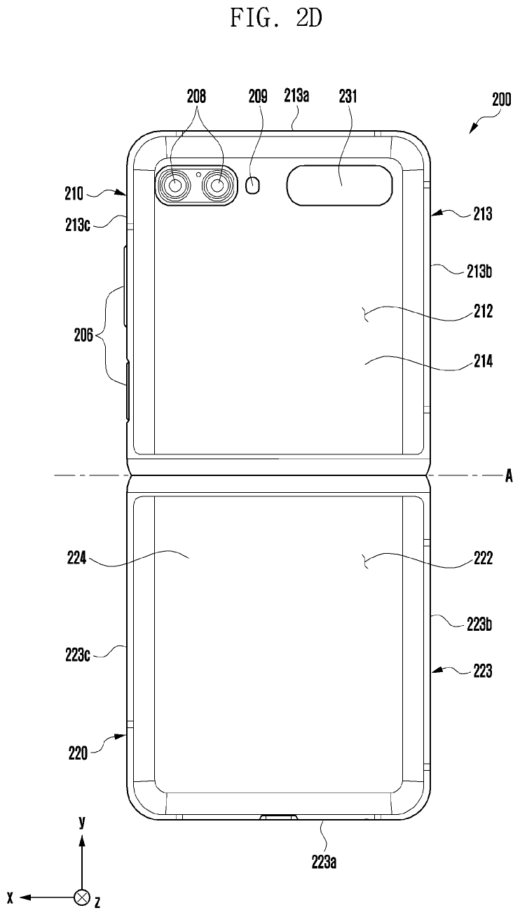

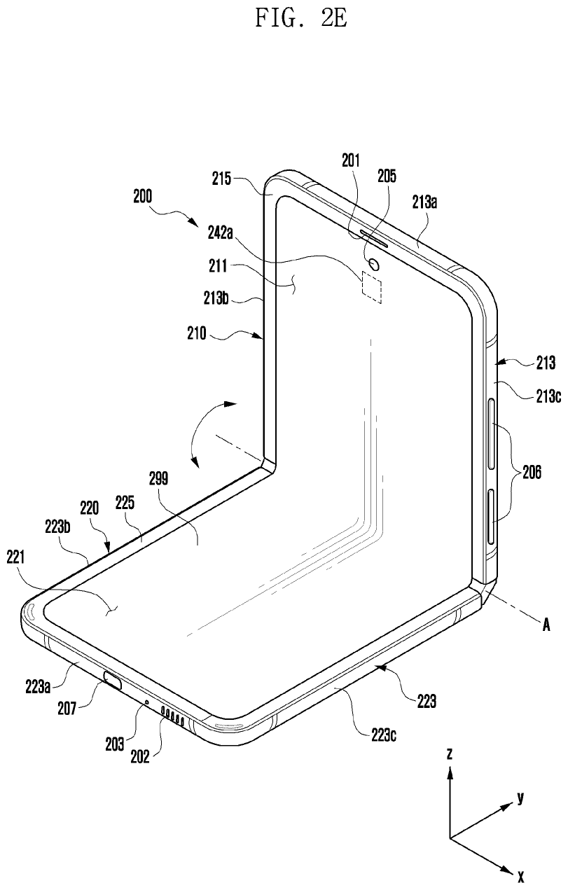

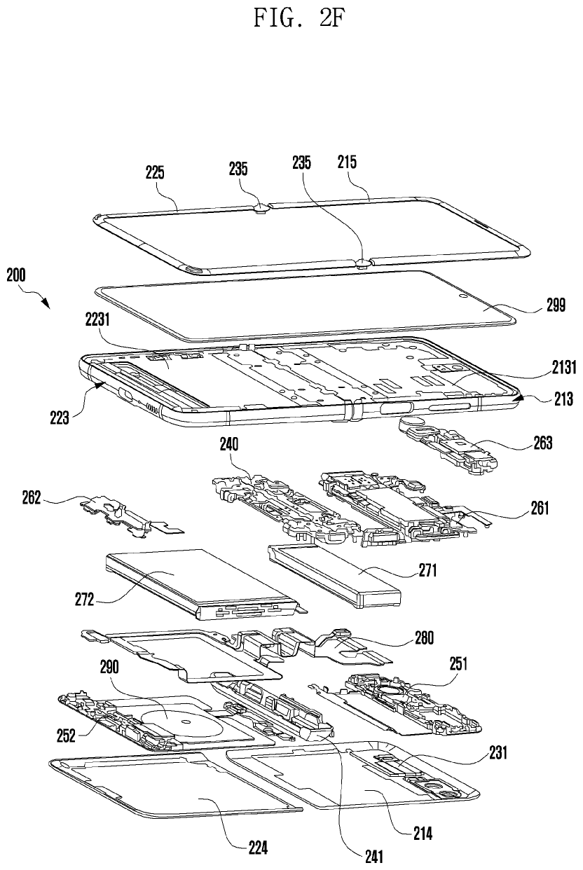

FIGS. 2A to 2F illustrate an embodiment of a foldable electronic device in the form of a mobile phone having an in-folding type housing structure constructed according to the principles of the invention. Specifically, FIGS. 2A and 2B illustrate the front of the foldable electronic device in an unfolded position. FIG. 2C is a perspective view illustrating the back of the foldable electronic device in a folded position. FIG. 2D is a plan view illustrating the back of the foldable electronic device in an unfolded position. FIG. 2E is a perspective view of the foldable electronic device in an intermediate position. FIG. 2F is an exploded perspective view of the foldable electronic device.

Referring to FIGS. 2A to 2F, a foldable electronic device 200 (e.g., the electronic device 101 in FIG. 1) may include an enclosure that maybe in the form of first housing 210, a second housing 220, a hinge that maybe in the form of a hinge assembly 240 interconnecting the first housing 210 and the second housing 220 such that the second housing 220 is rotatable relative to the first housing 210, a flexible or foldable display 299 disposed in a space defined by the foldable housings 210 and 220, and a sensor module (e.g., the sensor module 176 in FIG. 1).

The display 299 may be disposed from the first housing 210 to the second housing 220 across the hinge assembly 240. The display 299 may be divided into a first display area 211 disposed in the inner space of the first housing 210 and a second display area 221 disposed in the inner space of the second housing 220 with reference to the folding axis A. The sensor module (e.g., an illuminance sensor) may be disposed under a sensor area (or a light transmission area) 242a of the first display area 211 in a plan view. The location and/or size of the sensor area 242a in the first display area 211 may be determined by the location and/or size of the illuminance sensor disposed thereunder. For example, the size (e.g., the diameter) of the sensor area 242a may be determined based on a field of view (FOV) of the illuminance sensor. In an embodiment, the sensor area 242a may be configured to have a lower pixel density and/or a lower wiring density than that in the periphery thereof to improve light transmittance.

The hinge assembly 240 may be implemented to allow inward folding (in-folding type), which causes the two display areas 211 and 221 to face each other when the foldable electronic device 200 is switched from the expanded (e.g., unfolded) position (e.g., the position in FIGS. 2A, 2B, and 2D) to the compact (e.g., folded) position (e.g., the position in FIG. 2C). For example, when the electronic device 200 is in the unfolded position, the two display areas 211 and 221 may face substantially the same direction. As the position is changed from the unfolded position to the folded position, the two display areas 211 and 221 may be rotated in a direction in which the two display areas face each other. The hinge assembly 240 may be configured such that the foldable housings 210 and 220 has resistance to rotation. When an external force exceeding the resistance is applied to the foldable housings 210 and 220, the foldable housings 210 and 220 may be rotated.

Based on the angle formed between the two display areas 211 and 221, the position of the electronic device 200 may be defined. For example, the position of the electronic device 200 may be defined as an expanded, unfolded (in other words, flat, or open) position when the angle between the two display areas 211 and 221 is about 180 degrees. When the angle between the two display areas 211 and 221 is between about 0 and 10 degrees, the position of the foldable electronic device 200 may be defined as a compact, folded or closed position. When the two display areas 211 and 221 form an angle greater than the angle in the folded position and smaller than the angle in the unfolded position (e.g., between about 10 degrees and 179 degrees), the position may be defined as an intermediate position (in other words, a partially folded or partially unfolded position) as illustrated in FIG. 2E.

An active area in which visual information (e.g., text, image, or icon) is to be displayed on the display 299 may be determined based on the position of the foldable electronic device 200. For example, when the electronic device 200 is in the intermediate position, the active area may be determined as the first display area 211 or the second display area 221. Of the first display area 211 and the second display area 221, an area having a relatively smaller movement may be defined as the active area. For example, when the user holds one housing of the electronic device 200 with one hand and opens another housing with a finger (e.g., the thumb) of the same hand or the other hand, the electronic device 200 may be switched from the folded position to the intermediate position, and as a result, in the electronic device 200, the display area of the held housing (i.e., the housing having a relatively smaller movement) may be defined as the active area. When the foldable electronic device 200 is in the unfolded position, the entire area of the display 299 (e.g., both the first display area 211 and the second display area 221) may be defined as the active area.

In the unfolded position, the first housing 210 may include a first surface (a first display area) 211 oriented in a first direction (e.g., the front direction) (the z-axis direction) and a second surface 212 oriented in a second direction (e.g., a rear direction) (the −z-axis direction) in which the second surface faces away from the first surface 211. In the unfolded position, the second housing 220 may include a third surface (a second display area) 221 oriented in the first direction (e.g., the z-axis direction) and a fourth surface 222 oriented in the second direction (e.g., the −z-axis direction). The electronic device 200 may be operate such that, in the unfolded position, the first surface 211 of the first housing 210 and the third surface 221 of the second housing 220 are oriented in the same first direction (e.g., the z-axis direction), and, in the folded position, the first surface 211 and the third surface 221 face each other. The electronic device 200 may be operated such that, in the unfolded position, the second surface 212 of the first housing 210 and the fourth surface 222 of the second housing 220 are oriented in the same second direction (the z-axis direction), and, in the folded position, the second surface 212 and the fourth surface 222 face away from each other.

The first housing 210 may include a first side frame 213 forming at least a portion of the exterior of the electronic device 200 and a first rear cover 214 coupled to the first side frame 213 and forming at least a portion of the second surface 212 of the electronic device 200. According to an embodiment, the first side frame 213 may include a first side surface 213a, a second side surface 213b extending from one end of the first side surface 213a, and a third side surface 213c extending from the other end of the first side surface 213a. According to an embodiment, the first side frame 213 may be formed in a substantially rectangular (e.g., square or rectangular) shape via the first side surface 213a, the second side surface 213b, and the third side surface 213c.

A portion of the first side frame 213 may be formed of a conductor. For example, referring to FIG. 2B, a portion [symbol] of the first side surface 213a, a portion [symbol] of the second side surface 213b, and a portion [symbol] of the third side surface 213c may be formed of a metal material. The conductors may be electrically connected to grip sensors, respectively, which are disposed in the inner space of the first housing 210 adjacent thereto. A processor may measure the capacitances formed between the conductors and a ground (e.g., a ground of a main printed circuit board) via the grip sensors, and may recognize that a dielectric body (e.g., a finger, a palm, or a face) is adjacent to (or in contact with) the first housing 210 and a location that is contact with the dielectric body in the first housing 210 (e.g., the first side surface 213a, the second side surface 213b, or the third side surface 213c) based on the measured capacitance values.

The second housing 220 may include a second side frame 223 forming at least a portion of the exterior of the electronic device 200 and a second rear cover 224 coupled to the second side frame 223 and forming at least a portion of the fourth surface 222 of the electronic device 200. According to an embodiment, the second side frame 223 may include a fourth side surface 223a, a fifth side surface 223b extending from one end of the fourth side surface 223a, and a sixth side surface 223c extending from the other end of the fourth side surface 223b. According to an embodiment, the second side frame 223 may be formed in a rectangular shape via the fourth side surface 223a, the fifth side surface 223b, and the sixth side surface 223c.

A portion of the second side frame 223 may be formed of a conductor. For example, referring to FIG. 2B, a portion [symbol] of the fourth side surface 223a, a portion [symbol] of the fifth side surface 223b, and a portion [symbol] of the sixth side surface 223c may be formed of a metal material. The conductors may be electrically connected to grip sensors (not illustrated), respectively, which are disposed in the inner space of the second housing 220 adjacent thereto. A processor may measure the capacitance formed between the conductors and a ground (e.g., a ground of a main printed circuit board) via the grip sensors, and may recognize that a dielectric body is close to (or in contact with) the second housing 220 and a place that is contact with the dielectric body in the second housing 220 (e.g., the fourth side surface 223a, the fifth side surface 223b, or the sixth side surface 223c) based on the measured capacitance values.

Embodiments of the pair of housing structures 210 and 220 are not limited to the illustrated shape and assembly, but may be implemented in other shapes or other combinations and/or assemblies of components. For example, the first side frame 213 and the first rear cover 214 may be integrally formed, and the second side frame 223 and the second rear cover 224 may be integrally formed.

The first rear cover 214 and the second rear plate 224 may be formed of one or a combination of two or more of, for example, coated or colored glass, ceramic, polymer, or metal (e.g., aluminum, stainless steel (STS), or magnesium).

The electronic device 200 may include a first protective cover 215 (e.g., a first protective frame or a first decorative member) coupled along the edges of the first housing 210. The electronic device 200 may include a second protective cover 225 (e.g., a second protective frame or a second decorative member) coupled along the edges of the second housing 220. According to an embodiment, the first protective cover 215 and the second protective cover 225 may be formed of a metal or polymer material.

The electronic device 200 may include a sub-display 231 disposed separately from the display 299. According to an embodiment, the sub-display 231 is at least partially exposed on the second surface 212 of the first housing 210, so that when the electronic device 200 is in a folded position, the sub-display 231 may display information of the electronic device 200, such as its attitude or position. According to an embodiment, the sub-display 231 may be visible from the outside through at least a partial area in the first rear cover 214. In some embodiments, the sub-display 231 may be disposed on the fourth surface 224 of the second housing 220. In this case, the sub-display 231 may be visible from the outside through at least one area in the second rear cover 224.

The electronic device 200 may include at least one of an input device 203, a sound output device 201 or 202, a camera module 205 or 208, a key input device 206, a connector port 207, and a sensor module (not illustrated). In an embodiment, the sensor module (e.g., the sensor module 176 in FIG. 1), and the camera 205 may be disposed below the display 299 in a plan view.

The electronic device 200 may be operated to maintain the intermediate position via the hinge assembly 240. In this case, the electronic device 200 may control the display 299 to display different contents on the display area corresponding to the first surface 211 and the display area corresponding to the third surface 221, respectively.

Referring to FIG. 2F, the electronic device 200 may include a first side frame 213, a second side frame 223, and a hinge assembly 240 rotatably connecting the first side frame 213 and the second side frame 223 to each other. According to an embodiment, the electronic device 200 may include a first support plate 2131 at least partially extending from the first side frame 213 and a second support plate 2231 at least partially extending from the second side frame 223. According to an embodiment, the first support plate 2131 may be integrally formed with the first side frame 213 or may be structurally coupled to the first side frame 213. Similarly, the second support plate 2231 may be integrally formed with the second side frame 223 or may be structurally coupled to the second side frame 223. According to an embodiment, the electronic device 200 may include a display 299 supported by the first support plate 2131 and the second support plate 2231. According to an embodiment, the electronic device 200 may include a first rear cover 214 coupled to the first side frame 213 and providing a first space with the first support plate 2131, and a second rear cover 224 coupled to the second side frame 223 and providing a second space with the second support plate 2231. In some embodiments, the first side frame 213 and the first rear cover 214 may be integrally formed. In some embodiments, the second side frame 223 and the second rear cover 224 may be integrally formed. According to an embodiment, the electronic device 200 may include a first housing 210 provided via the first side frame 213, the first support plate 2131, and the first rear cover 214. Also, the electronic device 200 may include a second housing 220 provided via the second side frame 223, the second support plate 231, and the second rear cover 224.

The hinge assembly 240 may include a first arm structure coupled to the first housing 210 (e.g., the first support plate 2231), a second arm structure coupled to the second housing 220 (e.g., the second support plate 2232), and a detent structure that is in physical contact with the first arm structure and the second arm structure such that the first housing 210 and the second housing 220 have resistance to rotation. The foldable housings 210 and 220 may have resistance to rotation by the contact force of the detent structure (e.g., the force pushing the first arm structure and the second arm structure).

The electronic device 200 may include a first board assembly 261 (e.g., a main printed circuit board), a camera assembly 263, a first battery 271, or a first bracket 251 disposed in a first space between the first side frame 213 and the first rear cover 214. According to an embodiment, the camera assembly 263 may include a plurality of cameras (e.g., the camera modules 205 and 208 in FIGS. 2A and 2C), and may be electrically connected to the first board assembly 261. The first bracket 251 may provide a support structure for supporting the first board assembly 261 and/or the camera assembly 263 and improved rigidity. The electronic device 200 may include a second board assembly 262 (e.g., a sub printed circuit board), an antenna 290 (e.g., a coil member), a second battery 272, or a second bracket 252 disposed in a second space between the second side frame 223 and the second rear cover 224. The electronic device 200 may include a wiring member 280 (e.g., a flexible printed circuit board (FPCB)) disposed to extend from the first board assembly 261 across the hinge assembly 240 to a plurality of electronic components (e.g., the second board assembly 262, the second battery 272, or the antenna 290) disposed between the second side frame 223 and the second rear cover 224 and to provide an electrical connection.

The electronic device 200 may include a hinge cover 241, which is configured to support the hinge assembly 240, exposed to the outside when the electronic device 200 is in the folded position, and introduced into the first space and the second space to be invisible from the outside when the electronic device 200 is in the unfolded position.

The electronic device 200 may include a first protective cover 215 coupled along the edges of the first side frame 213. According to an embodiment, the electronic device 200 may include a second protective cover 225 coupled along the edges of the second side frame 223. In the display 299, the edges of the first display area 211 may be protected by the first protective cover 215. The edges of the second display area 221 may be protected by the second protective cover 225. Protective caps 235 may be disposed in an area corresponding to the hinge assembly 240 to protect bent portions of the edges of the display 299.

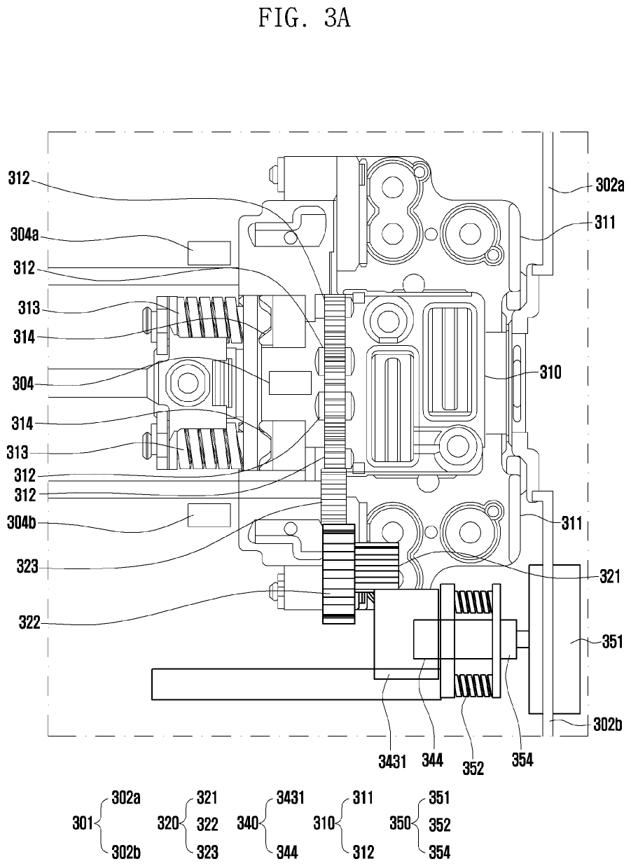

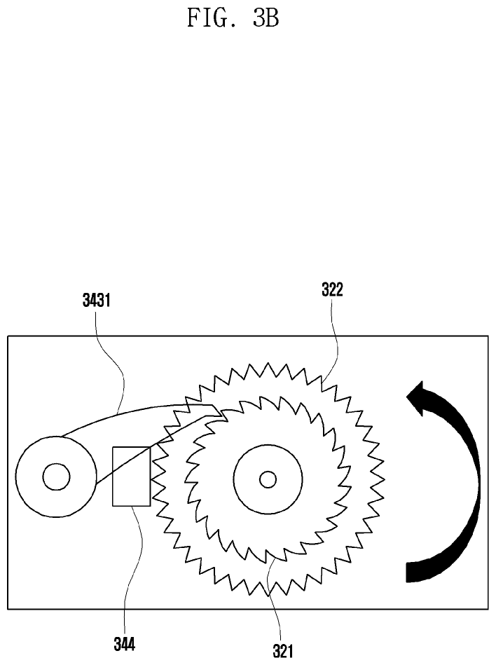

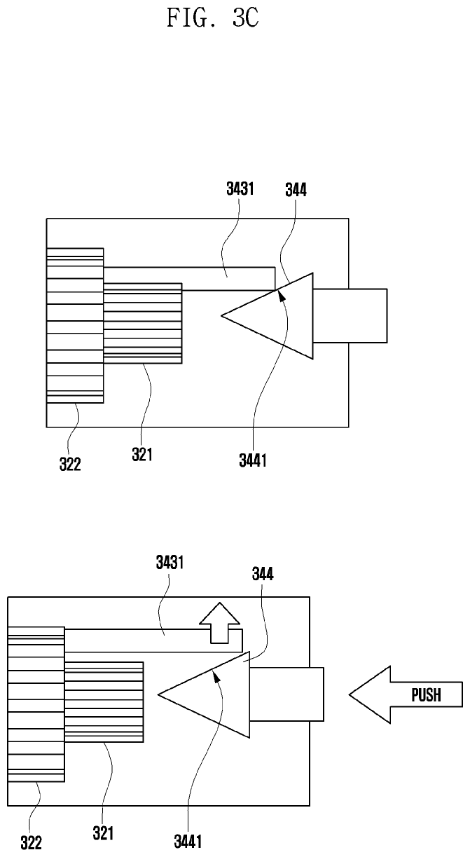

FIG. 3A is a cross-sectional view of a first embodiment of a hinge that may be in the form of a hinge part 310 of the foldable electronic device.

FIG. 3B is a cross-sectional view of a first embodiment of a follower that may be in the form of an interlocking part 320 (321 and 322) and a stop that may be in the form of a motion restriction member 340 (3431 and 344) of the foldable electronic device.

FIG. 3C is a schematic cross-sectional view illustrating an operation of the interlocking part 320 and the motion restriction member 340 of FIG. 3B.

Referring to FIG. 3A, the foldable electronic device (e.g., the electronic device 200 in FIGS. 2A to 2F) may include a foldable enclosure that may be in the form of a foldable housing 301, a hinge that may be in the form of a hinge part 310, a biaser that may be in the form of an elastic member 313, a follower that may be in the form of an interlocking part 320, a stop that may be in the form of a motion restriction member 340, and an actuator that may be in the form of a button part 350.

The foldable housing 301 (which may be the same as, for example, the foldable housings 210 and 220 in FIGS. 2A to 2F) may include a plurality of sub-housings 302a and 302b (e.g., a first housing 302a and a second housing 302b) in which components of the foldable electronic device, such as a foldable display (e.g., the foldable display 299 in FIGS. 2A to 2F), are located. The foldable housing 301 may be folded such that the sub-enclosures that may be in the form of sub-housings 302a and 302b is folded around hinge parts 310, which will be described later, to face each other in a compact position, or may be unfolded such that the sub-housings 302a and 302b are located in substantially the same plane defining an expanded position.

The hinge parts 310 (e.g., the hinge assembly 240 in FIGS. 2A to 2F) may be connected to the ends of the plurality of sub-housings 302a and 302b, respectively, and may be rotatable about at least one rotation axis so as to rotatably couple the sub-housings 302a and 302b to each other.

In some embodiments, the hinge parts 310 may include a plurality of hinge leaves 311 coupled to the one of the sub-housings 302a and 302b, and rotated with the sub-housings 302a and 302b and a plurality of hinge gears 312 configured to cause rotation actions of the hinge leaves 311 to be synchronized with each other during the rotation operation of the hinge.

In some embodiments, the foldable electronic device may include a folding sensor 304 (shown in FIG. 3A) configured to detect the rotation operation of the hinge. The folding sensor 304 may be, for example, a motion sensor, such as an optical encoder or a magnetic encoder, attached to the hinge parts 310. The folding sensor 304 may detect the folding or unfolding operation of the foldable electronic device and may generate a signal to cause the foldable electronic device to perform a selected operation. In another embodiment, the folding sensor 304 may include first and second folding sensors 304a and 304b secured relative to the first housing 302a and the second housing 302b, respectively. Each of the first and second folding sensors 304a and 304b may include an inertial sensor that measures an angular velocity of a rotation motion in at least one axial direction and an acceleration of a translation motion in at least one direction. By measuring and comparing the angular velocities and accelerations applied to the first housing 302a and the second housing 302b of the foldable housing, the folding or unfolding operation of the foldable housing can be detected. Measurement and comparison of angular velocities and accelerations may be performed, for example, by a signal processing processor or other processors (e.g., the processor 120 in FIG. 1) embedded in folding sensor 304. The inertial sensors may each include, for example, a MEMS inertial sensor driven by a piezoelectric element. The operation of the foldable electronic device based on signals detected by the folding sensor 304 will be described later.

The elastic member 313 may be a member configured to unfold the foldable housing 301 by applying a rotational force to the hinge by an elastic force. In some embodiments, the elastic member 313 may include a coil spring disposed substantially parallel to the rotation axis of the hinge. The axial thrust of the coil spring may be converted into a rotational force by a cylindrical cam 314 to drive the hinge. In another embodiment, the elastic member 313 may include various elastic rotation members 313 that apply a rotational force by an elastic force, such as a torsion bar, a torsion spring, a spiral spring, or a clockwork. When the elastic member 313 applies a rotational force to the hinge, the user may perform an unfolding operation of the foldable electronic device without directly applying a force to the foldable electronic device, thereby improving the user's convenience.

The interlocking part 320 may be a part that is located inside at least one of the sub-housings 302a and 302b and moves in an interlocking manner with the folding or unfolding operation of the foldable housing 301. The motion restriction member 340 may be a member that selectively restricts the movement of the interlocking part 320 by selectively coming into contact with or being separated from the interlocking part 320. The interlocking part 320 moves in an incremental such as step-wise manner with the folding or unfolding operation of the foldable housing 301, and since the motion restriction member 340 selectively restricts the movement of the interlocking part 320, the user may control the folding and/or unfolding operation of the foldable electronic device via the motion restriction member 340. The motion restriction member 340 may include a return spring 352 that returns the positions of the motion restriction member 340 and the button part 350 to be described later when the user does not manipulate the motion restriction member 340.

Various embodiments of the interlocking part 320 and the motion restriction member 340 will be described below with respect to FIGS. 3B and 3C.

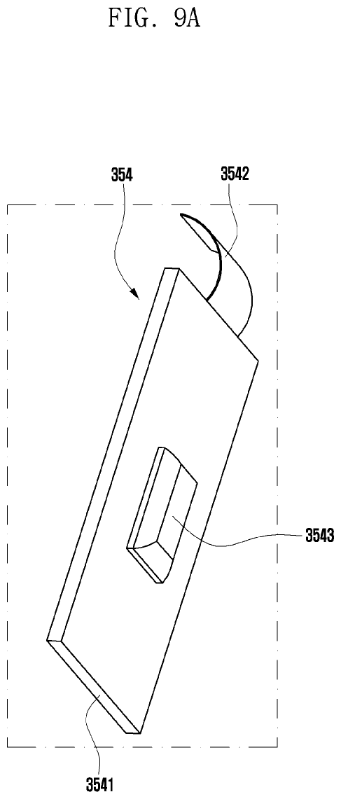

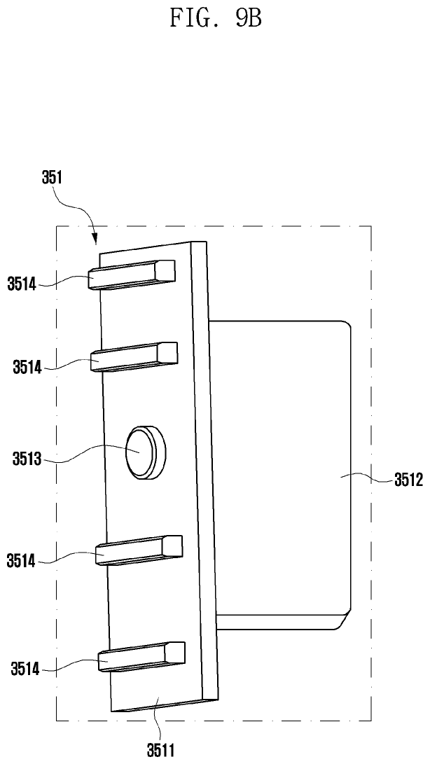

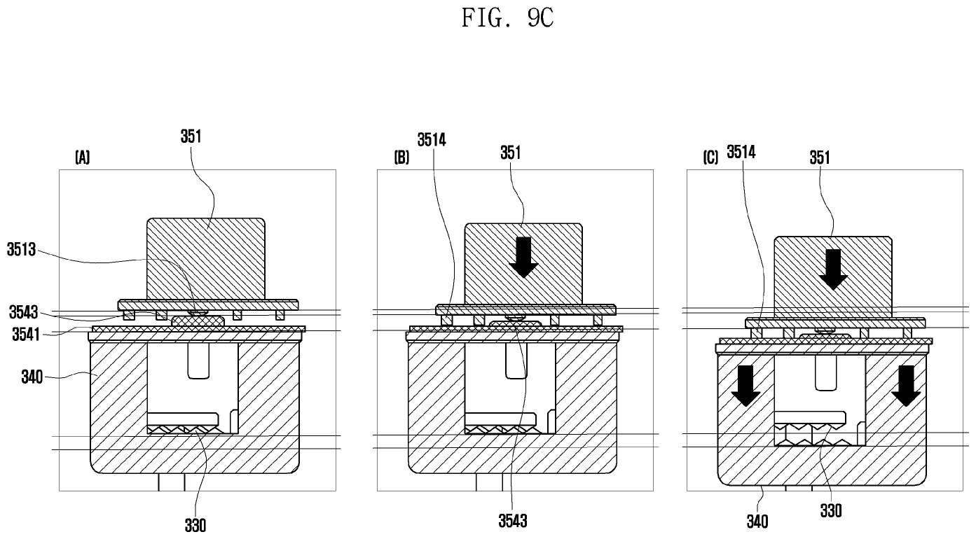

The button part 350 may be a member that drives the movement restriction member 340 to selectively come into contact with or be separated from the interlocking part 320 by being manipulated by the user. When the user manipulates the button part 350, the motion restriction member 340 is operated, and the movement of the interlocking part 320 is selectively restricted by the motion restriction member 340. Therefore, the user may control the folding and/or unfolding operation of the foldable electronic device. The button part 350 may include a push button 351 or a push lever that can be manipulated by being pushed or moved by the user. In some embodiments, the button part 350 may include an electrical switch 354 configured to generate an electrical signal in response to the user's manipulation and may be configured to also function as a power key (e.g., the key input device 206 in FIGS. 2A to 2F). In some embodiments, the movement restriction member 340 may include a button base 341 having a surface oriented in the direction in which the push button 351 or the push lever is manipulated. The electrical switch is disposed on the oriented surface. When the user does not press the push button 351, the return spring 352 presses the button base 341, and the button base 341 presses the electrical switch 354 and the push button 351, whereby the push button 351 can be returned. The foldable electronic device may determine whether or not the button part 350 is manipulated by the user using the electrical switch 354, and may perform a selected operation depending on whether or not the button part 350 is manipulated by the user. The operation of the foldable electronic device based on the manipulation of the electrical switch 354 of the button part 350 will be described later with FIGS. 9A to 9C.

Referring to FIGS. 3A to 3C, the interlocking part 320 may include a ratchet wheel 321, and the motion restriction member 340 may include a ratchet pawl 3431.

The ratchet wheel 321 may be a disk-shaped member that is rotated about an axis and having a plurality of teeth provided on the outer periphery thereof. In some embodiments, the interlocking part 320 may include a first interlocking gear 322 coupled with the ratchet wheel 321 about the same axis as the ratchet wheel 321. Referring to FIGS. 3A and 3B, the interlocking part 320 may further include a second interlocking gear 323, which is engaged with the hinge gear 312 of the hinge part 310 and the first interlocking gear 322 to make the ratchet wheel 321 interlock with the rotation action of the ratchet wheel 321.

The ratchet pawl 331 may be a member that stops rotation of the ratchet wheel 321 by being selectively engaged with the ratchet wheel 321. In some embodiments, the motion restriction member 340 may include a wedge member 344, which is driven by the button part 350 and has an inclined surface 3441, wherein, when moving relative to the ratchet pawl 331, the inclined surface 3441 moves the ratchet pawl 331 in a direction in which the ratchet pawl 331 is disengaged from the ratchet wheel 321. When the button part 350 is pushed by the user, the wedge member 344 moves the ratchet pawl 331 to disengage the ratchet pawl 331 and the ratchet wheel 321 from each other, whereby the ratchet wheel 321 can be rotated, and thus the hinge can be rotated to fold or unfold the foldable electronic device.

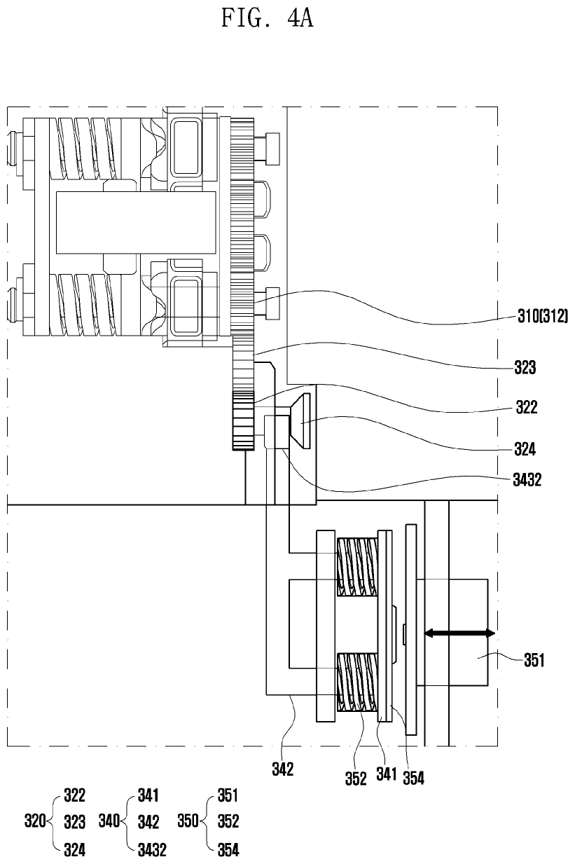

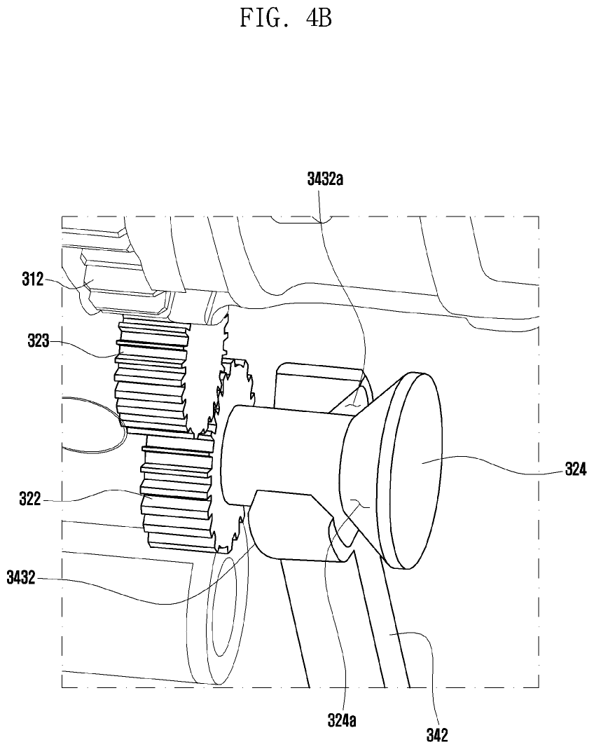

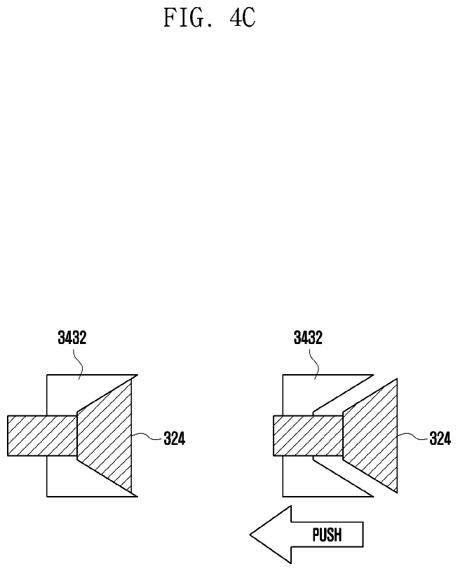

FIG. 4A is a cross-sectional view of a second embodiment of a hinge part 310 (312) of the foldable electronic device.

FIG. 4B is an enlarged perspective view of a second embodiment of an interlocking part 320 (322, 323, and 324) and a motion restriction member 340 (341, 342, and 3432) of the foldable electronic device.

FIG. 4C is a schematic cross-sectional view illustrating an operation of the interlocking part 324 and the motion restriction member 3432 of FIG. 4B.

Referring to FIGS. 4A and 4B, the interlocking part 320 may include a brake rotor 324, and the motion restriction member 340 may include a brake shoe 3432. In some embodiments, the brake rotor 324 may include a brake drum having a truncated cone shape, and a first friction surface 324a may be formed on the side surface of the truncated cone shape. The brake shoe 3432 may include a second friction surface 3432a having a shape corresponding to the first friction surface 324a. The truncated cone-shaped brake rotor 324 may have an advantage in that the area of the first friction surface 324a can be increased compared to a cylindrical shape or disk shape having the same diameter. The brake rotor 324 may be coupled to the first interlocking gear 322 about the same axis as the first interlocking gear 322, and may be interlocked with the hinge gear 312 of the hinge part 310 via the second interlocking gear 323.

The motion restriction member 340 may include a beam 342 connecting the brake shoe 3432 to the button base 341. When the button part 350 is not pushed, the return spring 352 presses the button base 341, and the force of the return spring 352 is transmitted to the brake shoe 3432 of the motion restriction member 340 via the beam 342 to bring the brake shoe 3432 into contact with the brake rotor 324 and to press the brake shoe 3432 against the brake rotor 324. In a position in which the brake shoe 3432 presses the brake rotor 324, the folding and unfolding operations may be restricted due to a frictional force applied to the brake rotor 324. By adjusting the number, arrangement, and spring coefficient of return springs 352, the strength of the frictional force can be adjusted.

Referring to FIG. 4C, when the button part 350 (shown in FIG. 4A) is pushed, the brake shoe 3432 may be separated from the brake rotor 324. Since no frictional force is applied to the brake rotor 324 when the brake shoe 3432 is separated, the brake rotor 324 is freely rotatable so that the folding or unfolding operation of the foldable electronic device according to the rotation of the hinge gear 312 can be performed.

Since the folding or unfolding operation of the foldable electronic device is controlled by the brake rotor 324 and the brake shoe 3432, there is an advantage in that the foldable housing 301 can be fixed at an arbitrary folding angle. The description, “the foldable housing 301 can be fixed at any folding angle”, may be referred to as “free stop”. In addition, when a force for folding or unfolding the foldable electronic device is applied from the outside in the position in which the user does not manipulate the button part 350, the brake shoe 3432 and the brake rotor 324 may allow rotation while slipping, thereby allowing the folding or unfolding of the foldable electronic device. Therefore, even if the user folds or unfolds the foldable electronic device without manipulating the button part 350, the risk of damage to the hinge part 310 and/or the interlocking part 320 may be reduced.

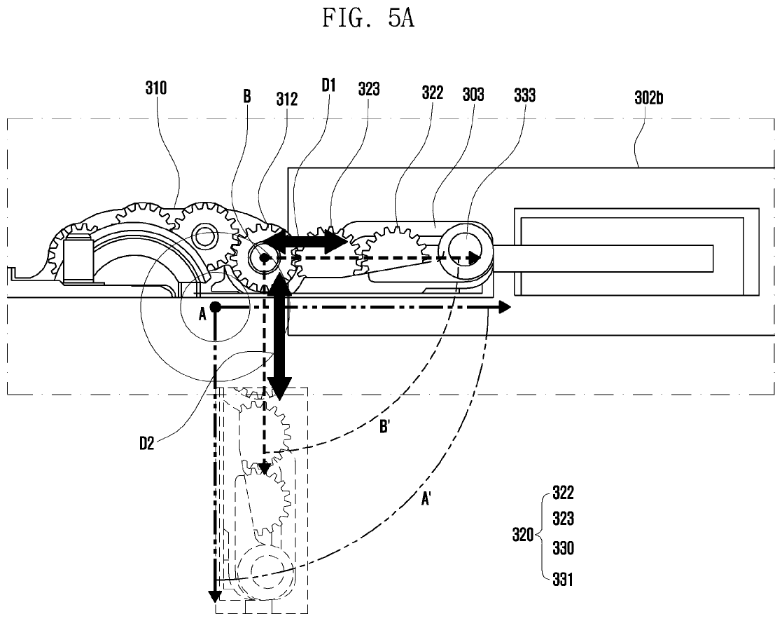

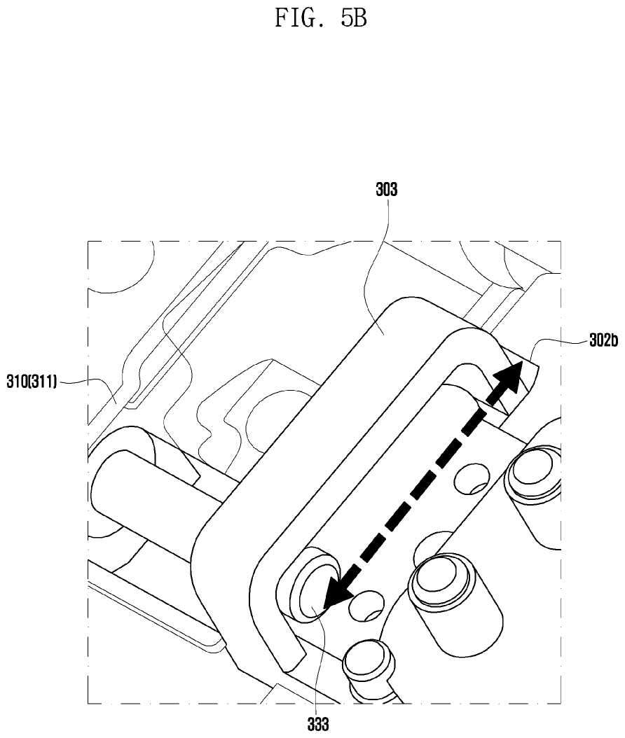

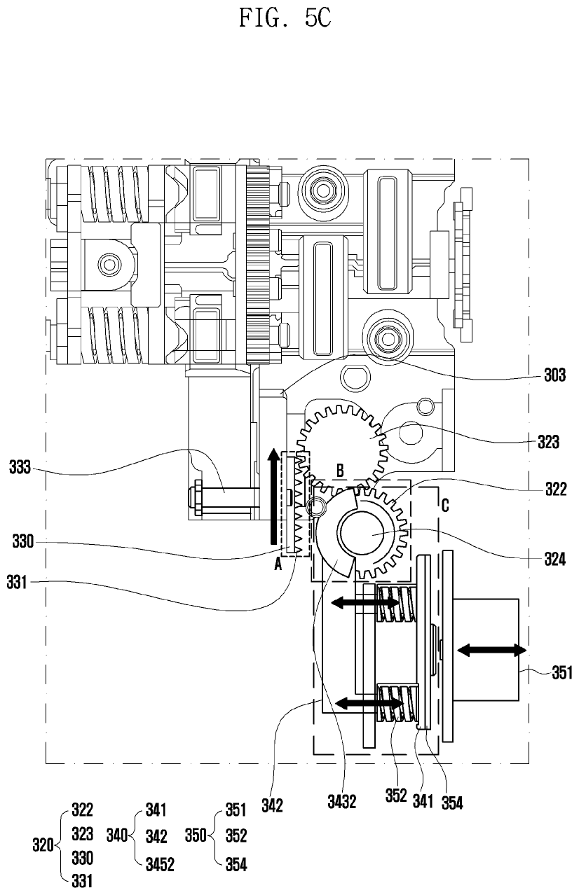

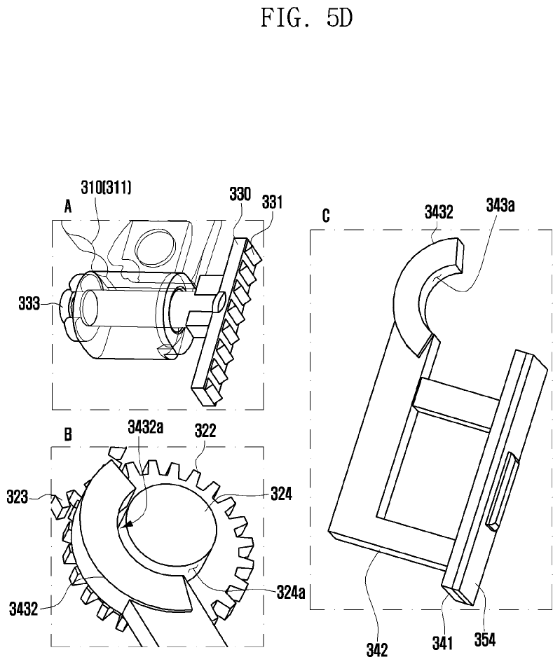

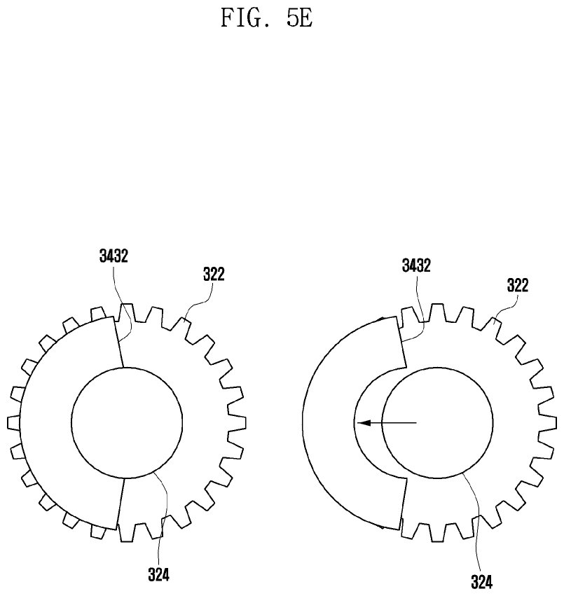

FIG. 5A is a cross-sectional view illustrating an operation of third embodiment of a hinge part 310 of the foldable electronic device.

FIG. 5B is an enlarged perspective view illustrating the sliding pin 333 of the foldable electronic device of FIG. 5A.

FIG. 5C is a cross-sectional view of a third embodiment of an interlocking part 320 (322, 323, 330 and 331) and a motion restriction member 340 (341, 342 and 3452) of the foldable electronic device.

FIG. 5D is an enlarged perspective view of the interlocking part and a motion restriction member of FIG. 5C.

FIG. 5E is a schematic cross-sectional view illustrating an operation of the interlocking part and the motion restriction member of FIG. 5D.

Referring to FIG. 5A, the rotation axis A of a sub-housing 302 (e.g., a second housing 302b) of the foldable electronic device may be spaced apart from the rotation axis B of the hinge gear 312 of the hinge part 310. In this case, the rotation trajectory A′ of the sub-housing 302b and the rotation trajectory B′ of a hinge leaf 311 (shown in FIG. 3A) of the hinge part 310 may be different from each other. Accordingly, the distance (D1, D2) between the hinge gear 312 of the hinge part 310 and the first interlocking gear 322 located in the sub-housing 302b may vary at the time of folding and unfolding operations of the foldable housing 301 which includes a plurality of sub-housings 302a and 302b (e.g., a first housing 302a and a second housing 302b). The configuration of the hinge part 310 rotating about the rotation axis spaced apart from the rotation axis of the hinge gear 312 may be referred to as a blooming hinge. The blooming hinge may compensate for the thickness of the hinge part 310 and/or the foldable housing 301 to provide assistance such that the foldable display (e.g., the foldable display 299 in FIG. 2F) can be unfolded to be flat when the foldable electronic device is unfolded.

Referring to FIG. 5B, in order to compensate for the change in the distance between the sub-housings 302a and 302b (shown in FIG. 3A) and the hinge shaft, the foldable electronic device may include a sliding pin 333 fixed relative to the hinge leaf 311 of the hinge part 310, and a sliding guide 303 fixed to the sub-housing 302b of the foldable housing 301 and slidably coupled to the sliding pin 333.

Referring to FIGS. 5C and 5D, the interlocking part 320 (shown in FIG. 5A) may include a movable member that may be in the form of a sliding member 330. The sliding member 330 may be a member that is interlocked with the folding and unfolding operations of the foldable housing 301 and slides relative to the sub-housings 302a and 302b. In some embodiments, the sliding member 330 may be coupled to the sliding pin 333. The sliding member 330 may include a rack 331 having gear teeth linearly arranged in the direction in which the sliding member 330 slides. The second interlocking gear 323 of the interlocking part 320 may be a pinion gear that is rotated in engagement with the rack 331. The second interlocking gear 323 may be engaged with the first interlocking gear 322 coupled on the same rotation axis as the brake rotor 324. The brake rotor 324 may have a first friction surface 324a having a cylindrical shape, and the brake shoe 3432 of the motion restriction member 340 may have a second friction surface 3432a having a shape corresponding to the cylindrical shape of the brake rotor 324.

When the button part 350 (351, 352 and 354 shown in FIG. 5C) is not pushed, the return spring 352 of the button part 350 may bring the brake shoe 3432 of the motion restriction member 340 into contact with the brake rotor 324 and may press the brake shoe 3432 against the brake rotor 324 via the beam 342. In a position in which the brake shoe 3432 presses the brake rotor 324, the folding operation may be restricted due to the frictional force applied to the brake rotor 324. Referring to FIG. 5D, the brake shoe 3432 may be coupled to the button part 350 via the beam 342. In some embodiments, an electrical switch 354 is located on a surface of the beam 342 that is pressed by the push button 351 of the button part 350 so that the electrical switch 354 can generate an electrical signal when the button part 350 is pushed.

Referring to FIG. 5E, when the button part 350 is pushed, the brake shoe 3432 may be separated from the brake rotor 324. Since no frictional force is applied to the brake rotor 324 when the brake shoe 3432 is separated, the brake rotor 324 is freely rotatable so that the folding or unfolding operation of the foldable electronic device according to the rotation of the hinge can be performed.

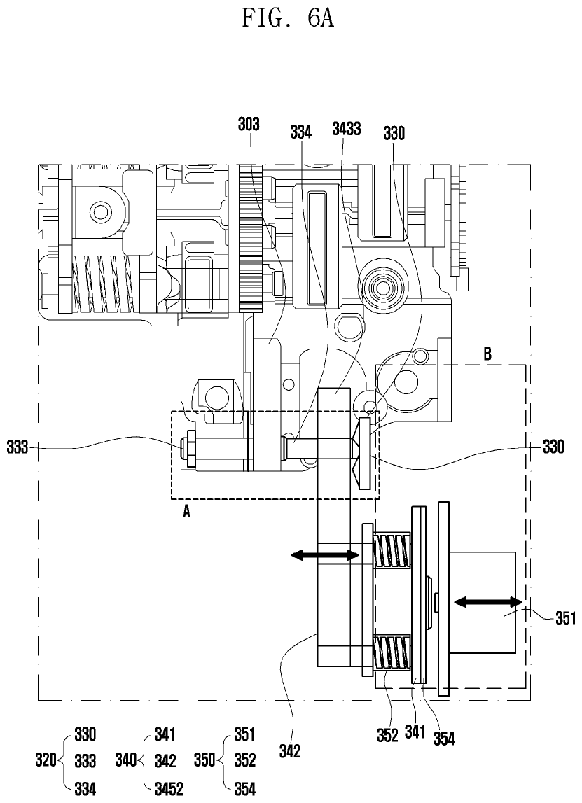

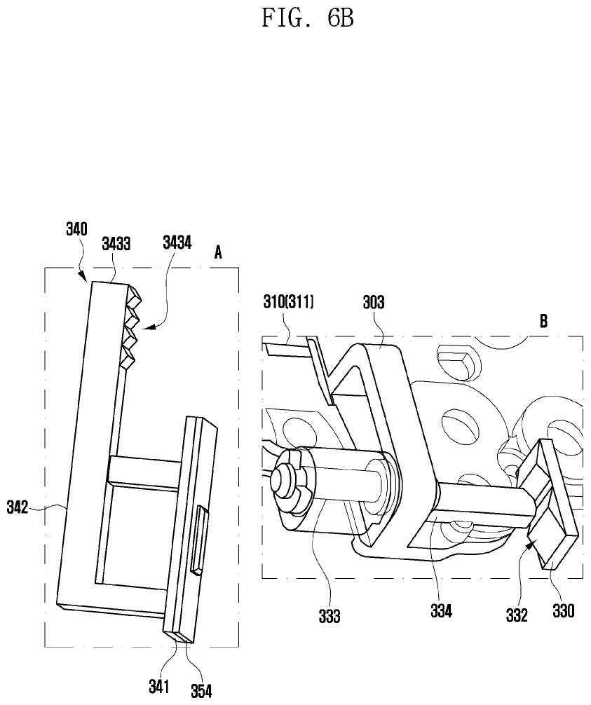

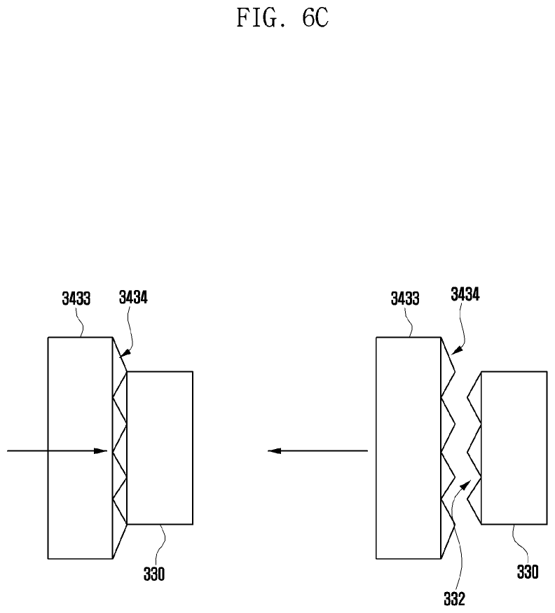

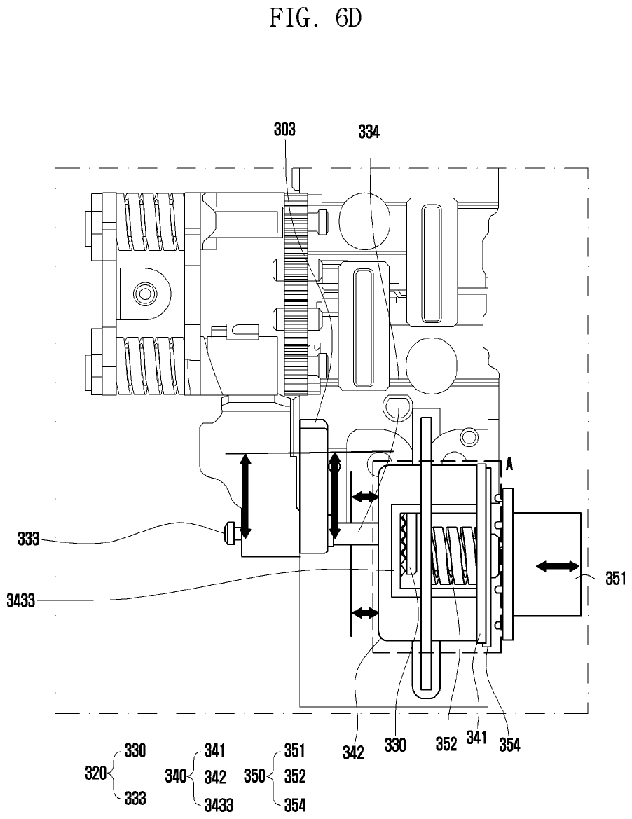

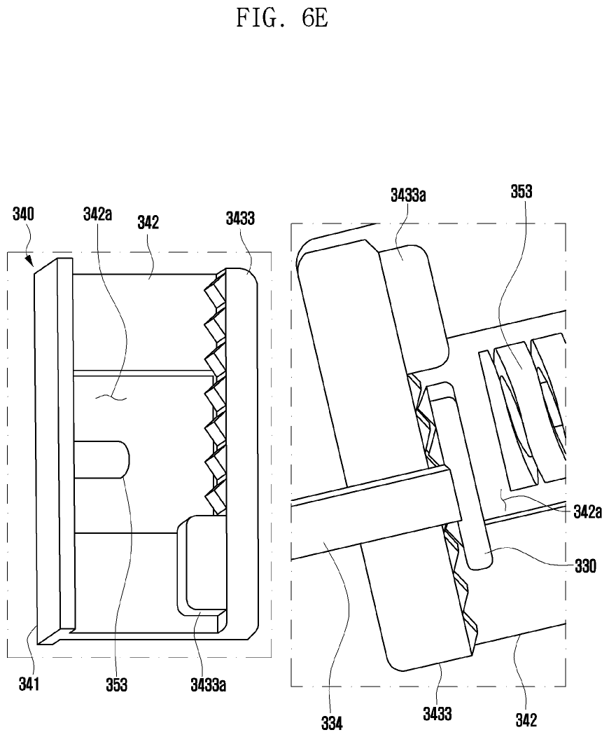

FIG. 6A is a cross-sectional view of a fourth embodiment of a hinge part of the foldable electronic device.

FIG. 6B is an enlarged perspective view of a fourth embodiment of the interlocking part 320 and a motion restriction member 340 of FIG. 6A.

FIG. 6C is a schematic cross-sectional view illustrating an operation of the interlocking part 330 and the motion restriction member 3433 of FIG. 6B.

FIG. 6D is a cross-sectional view of a fifth embodiment of a hinge part of the foldable electronic device.

FIG. 6E is an enlarged perspective view of a fifth embodiment of the interlocking part 320 and the motion restriction member 340 of FIG. 6D.

Referring to FIGS. 6A and 6B, the interlocking part 320 may include a sliding cantilever 334 extending from the sliding pin 333 and a sliding member 330. The sliding member 330 may include a sliding friction surface 332. The sliding member 330 may be disposed at the distal end of the sliding cantilever 334 such that the sliding friction surface 332 is oriented in a direction opposite to the direction in which the button part is pushed by the user. The motion restriction member 340 may include a linear brake 3433 including a surface 3434 facing the sliding friction surface 332, wherein the linear brake 3433 applies a frictional force to the sliding member 330 by bringing the linear friction surface into contact with the sliding friction surface 332 and is operated by the button part 350 via the beam 342.

Referring to FIG. 6C, when the user does not manipulate the button part 350, the return spring 352 may press the base plate of the button part 350, and the linear brake 3433 may be pressed against the sliding friction surface 332 of the sliding member 330 by the beam 342 coupled to the base plate to apply a frictional force against the movement of the sliding member 330. When the user manipulates the button part 350, the linear brake 3433 is separated from the sliding member 330 to release the frictional force, and no resistance is applied against the folding and unfolding operations.

In some embodiments, at least one of the sliding friction surface 332 and/or the surface of the linear brake 3433 facing the sliding friction surface 332 may include an irregularity. The irregularity may increase the frictional force applied by the linear brake 3433 to the sliding member 330. The configuration of the irregularity will be described later.

Referring to FIGS. 6D and 6E, in another embodiment, the motion restriction member 340 may include a plate-shaped beam 342 extending in a direction perpendicular to the button base 351 from the center of the button base 341 in the long axis direction, wherein the plate-shaped beam 342 is cut to form a hollow portion 342a such that the return spring 352 and a support rod 353 supporting the return spring 352 are located in the hollow portion 342a. The linear brake 3433 may be arranged in a bent direction at the distal end of the plate-shaped beam 342. Since the beam 342 has a plate shape, it is possible to stably support the linear brake 3433 with respect to the button base 341. In some embodiments, the brake may include a latch 3433a, which is a member that restricts the range of motion of the sliding member and prevents the button base from being jammed due to excessive pressing by the return spring 352.

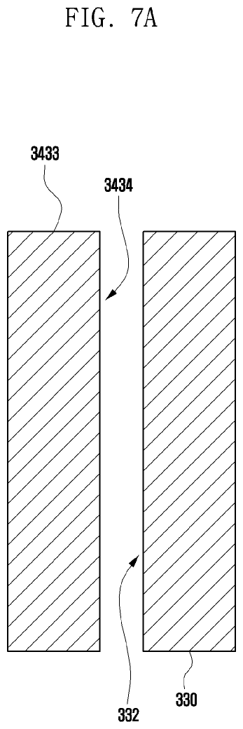

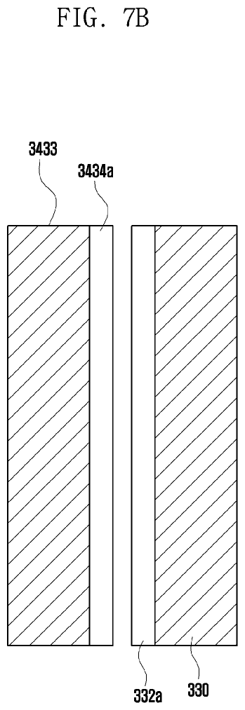

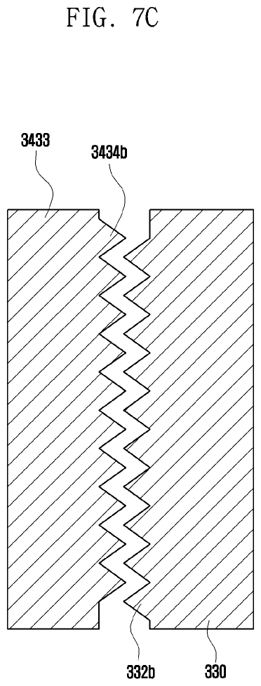

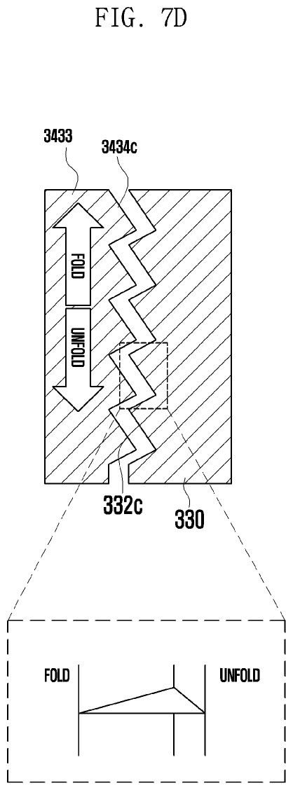

FIGS. 7A to 7D are schematic cross-sectional views of various embodiments of a sliding member 330 and a linear brake 3433 of FIGS. 6A to 6E.

Referring to FIG. 7A, the sliding member 330 may include a sliding friction surface 332, and the linear brake 3433 may include a friction surface 3434 facing the sliding friction surface 332. Referring to FIG. 7B, in some embodiments, the sliding member 330 may include a first brake pad 332a attached on the sliding friction surface 332, and the linear brake 3433 may include a second brake pad 3434a attached on the surface 3434 facing the sliding friction surface 332 to face the first brake pad 332a. The first and second brake pads 332a and 3434a may include a material having high frictional force and high heat resistance, such as rubber, carbon fiber, Kevlar fiber, ceramic, a metallic sintered compact, or a combination thereof. Since the sliding member 330 and the linear brake 3433 include the first brake pad 332a and the second brake pad 3434a, respectively, it is possible to reduce problems such as abrasion and thermal damage due to heat generation caused when the structural materials of the sliding member 330 and the linear brake 3433 directly rub against each other.

Referring to FIG. 7C, in some embodiments, the sliding member 330 and the linear brake 3433 may respectively include irregularities 332b and 3434b formed on the sliding friction surface 332 and the surface 3434 facing the sliding friction surface 332. The irregularities 332b and 3434b may improve the friction coefficient of the frictional force applied by the linear brake 3433 to the sliding member 330. Accordingly, by reducing the elastic force of the return spring 352 required to apply the same frictional force, it is possible to reduce the force required for the user to manipulate the button part 350. The number, height, and shape of the irregularities 332b and 3434b may be adjusted to obtain a level of frictional force required to stop the folding and unfolding operations of the foldable housing 301. Although not illustrated, in some embodiments, the irregularities 332b and 3434b may be formed on the first brake pad 332a and the second brake pad 3434a, respectively.

Referring to FIG. 7D, in some embodiments, the sliding member 330 and the linear brake 3433 may respectively include asymmetric irregularities 332c and 3434c formed on the sliding friction surface 332 and the surface 3434 facing the sliding friction surface 332. The asymmetric irregularities 332c and 3434c may have a relatively gentle slope with respect to the direction in which the sliding member 330 moves when the foldable housing 301 is folded, and a relatively steep slope with respect to the direction in which the sliding member 330 when the foldable housing 301 is unfolded. Since the sliding member 330 and the linear brake 3433 include the asymmetric irregularities 332c and 3434c, respectively, a relatively weak frictional force may be applied when the foldable electronic device is folded, and a relatively strong frictional force may be applied when the foldable electronic device is unfolded. In order to automate the unfolding operation of the foldable electronic device, the elastic member 313 applies a rotational force to the hinge part 310 in the rotation direction in which the foldable electronic device is unfolded. Thus, stopping the unfolding operation applies a relatively large load to the motion restriction member 340 compared to stopping the folding operation. Therefore, it may be desirable for the interlocking part 320 and the motion restriction member 340 to apply a relatively stronger frictional force for the unfolding operation.

In the illustrated embodiments, the frictional force applied by the motion restriction member 340 is set equal to or greater than the force applied to the interlocking part 320 by the elastic force applied by the elastic member 313 to the hinge part 310. In addition, the frictional force may be set to a level capable of allowing slip between the motion restriction member 340 and the interlocking part 320 while avoiding damage to the hinge part 310, the interlocking part 320, and the motion restriction member 340 when folding and unfolding operations of the foldable electronic device are performed.

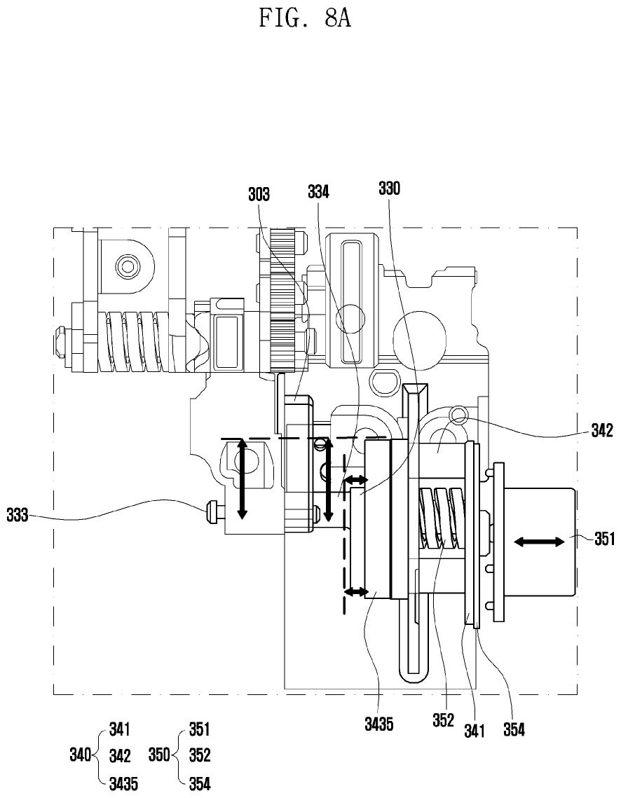

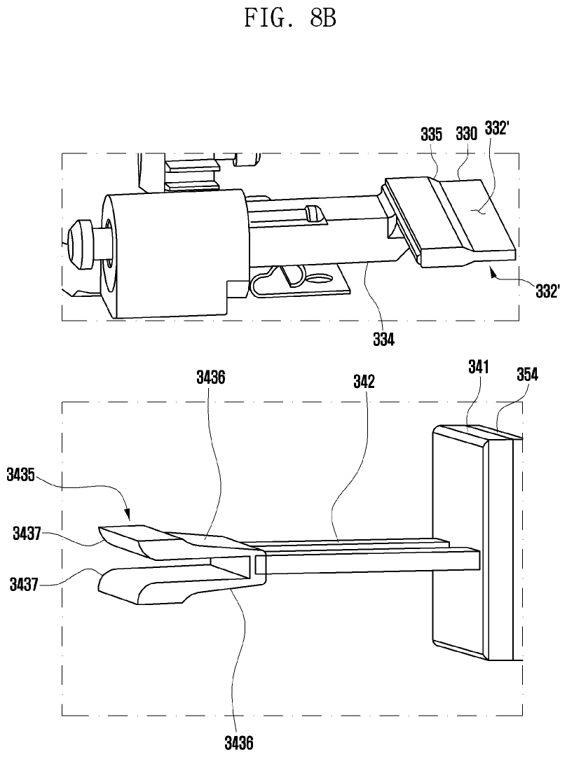

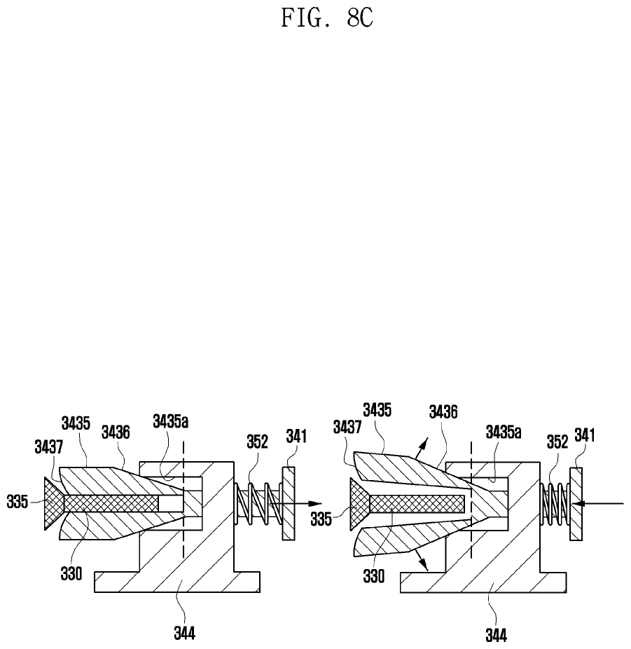

FIG. 8A is a cross-sectional view of a sixth embodiment of a hinge part of the foldable electronic device.

FIG. 8B is an enlarged perspective view of a sixth embodiment of the sliding member 330 and the motion restriction member 340 of FIG. 8A.

FIG. 8C is a schematic cross-sectional view illustrating an operation of the sliding member 330 and the motion restriction member 340 of FIG. 8B.

Referring to FIGS. 8A and 8B, the sliding member 330 may include a plurality of second sliding friction surfaces 332′ disposed to face each other, and the motion restriction member 340 may include a clamp 3435 configured to apply a frictional force to the plurality of second sliding friction surfaces 332′ by holding the sliding member 330. The clamp 3435 is is disposed to face the second sliding friction surfaces 332′ at the distal end of the beam 342, and may be coupled to the distal end of the beam 342 to be movable toward the second sliding friction surfaces 332′. In some embodiments, the clamp 3435 may be rotatably coupled to the distal end of the beam 342 via a living hinge made of a material having high stiffness, low viscosity, and high fatigue resistance, such as polypropylene and/or acrylonitrile butadiene styrene (ABS).

Referring to FIG. 8C, the motion restriction member 340 may include a clamp housing 344 including an inner space into which at least a portion of the clamp 3435 is inserted, and the clamp 3435 may include an inclined surface 3436, which is in contact with an inner surface 3435a of the clamp housing 344. A return spring 352 is located between the button base 341 and the clamp housing 344 to press the button base 341, so that the return spring 352 can press the button base 341. Accordingly, the clamp 3435 coupled to the button base 341 via the beam 342 may be inserted into the clamp housing 344 by the return spring 352. When the clamp 3435 is inserted into the clamp housing 344, the inclined surface 3436 slides while being in contact with the inner surface 3435a of the clamp housing 344, and since the clamp 3435 is pressed against the second sliding friction surfaces 332′ by the inclined surface 3436, the clamp 3435 may hold the sliding member 330.

Referring back to FIG. 8C, the sliding member 330 may include an expansion portion 335 in which the thickness of the sliding member 330 is gradually increased. The expansion portion 335 may be located at the base portion of the second sliding friction surfaces 332′. The clamp 3435 may include a curved portion 3437 formed at the distal end facing the expansion portion 335. When the button part 350 is manipulated by the user so that the button base 341 is pressed and the clamp 3435 is moved toward the base portion of the sliding member 330, the curved portion 3437 is moved along the surface of the expansion portion 335, whereby the clamp 3435 may be opened and the sliding member 330 may be released and slid.

Since the clamp 3435 is opened by the expansion portion 335 and the sliding member 330 is released when the user manipulates the button, the clamp 3435 does not require a separate elastic member for release, and the elastic force of the return spring 352 does not need to be large in order to overcome the elastic force of the elastic member of the clamp 3435. Therefore, there is an advantage in that the button is soft to be easily pushed by the user.

FIG. 9A is a perspective view of an embodiment of an electrical switch 354 of a button part 350 of the foldable electronic device.

FIG. 9B is a perspective view of an embodiment of a push button 351 of the foldable electronic device.

FIG. 9C is a schematic cross-sectional view illustrating an operation of the button part 350 and members of the foldable electronic

Referring to FIG. 9A, the button part 350 of the foldable electronic device may include an electrical switch 354. The electrical switch 354 may include a switch board 3541, a switch cable 3542, and an elastic dome 3543. The switch board 3541 may be a member on which a switch circuit is disposed. The switch circuit may include, for example, a plurality of conductive patterns disposed on the board to be electrically spaced apart from each other in a position of being adjacent to each other. The material of the board may be a printed circuit board (PCB) or a flexible printed circuit board (FPCB). Since the flexible printed circuit board has a small thickness, the flexible printed circuit board may occupy a small amount of the internal space of the flexible electronic device. In some embodiments, the button part 350 may be located above the switch board 3541 to be spaced apart from a plurality of conductors and may include a membrane including a conductor and pressed against the switch board 3541 to come into contact with and interconnect the plurality of conductor patterns when the user manipulates the button part 350.

The elastic dome 3543 may be a member that is pressed and elastically deformed when the user manipulates the push button 351 to electrically connect the switch circuit, and that is restored by elasticity when the manipulation is finished. In some embodiments, the elastic dome 3543 may include a thin metal material that is shaped in a dome shape and comes into contact with the plurality of conductor patterns when elastically deformed. In another embodiment, the elastic dome 3543 may include a material such as TPU or silicone rubber, and may be a member for electrically connecting a plurality of conductor patterns to each other by pressing the conductor disposed on the membrane.

The switch cable 3542 may be a member that transmits an electrical signal generated by the electrical switch 354 to another component of the electronic device, for example, the processor 120 of FIG. 1. Preferably, the switch cable 3542 may be a cable having a small thickness, such as a ribbon cable, a flexible flat cable (FFC), or a flexible printed cable (FPC). Electrical signals generated by the electrical switch 354 may be associated with, for example, an operation of turning on/off of the foldable electronic device and/or a display, a voice recognition AI call operation, and/or various operations of the foldable electronic device set by the user. In addition, the foldable electronic device may be set to perform various operations by causing the electrical signals generated by the electrical switch 354 to be associated with signals generated from the folding sensor 304. Various operations of the foldable electronic device associated with the electrical switch 354 and the folding sensor 304 will be described later.

Referring to FIG. 9B, the push button 351 may include a manipulation portion 3512, a protrusion 3513, and a main body portion 3511. The manipulation portion 3512 may be a portion that protrudes to the outside of the foldable housing 301 and is manipulated by the user. The manipulation portion 3512 may have a hexahedral shape as illustrated in FIG. 9B. However, this is an example, and the manipulation portion 3512 may have various shapes such as a cylindrical shape or a hemispherical shape. The protrusion 3513 may be a portion that presses the electrical switch 354 when the push button 351 is pushed. The main body portion 3511 may provide a base to which the manipulation portion 3512 and the protrusion 3513 are coupled. In some embodiments, the push button 351 may include ribs 3514 that supplements the rigidity of the main body portion 3511 and adjusts the pushed depth of the push button 351.

In some embodiments, the push button 351 may include a biometric sensor located on a surface to be touched by the user's finger when the push button 351 is manipulated by the user. The biometric sensor may be various sensors that recognize the user's unique biometric data, such as a fingerprint recognition sensor and/or a vein pattern sensor. The biometric sensor may detect the user's unique biometric data for performing an unlocking operation of the foldable electronic device in association with an electrical signal generated by the button part 350 or performing various functions (e.g., electronic payment and/or user authentication) associated with user identification, for example, fingerprint pattern or vein pattern data.

Referring to (A) of FIG. 9C, in an initial position, the motion restriction member 340 applies a frictional force by pressing the interlocking part 320 (e.g., the sliding member 330), and the push button 351 is supported by the elastic dome 3543. Referring to (B) of FIG. 9C, when the user starts to push the push button 351, the push button 351 presses the elastic dome 3543 so that an electrical signal can be generated by in the electrical switch 354. In some embodiments, the elastic dome 3543 can be prevented from being excessively pressed by the ribs 3514 supporting the push button 351 in the position in which the elastic dome 3543 is sufficiently pressed. Referring to (C) of FIG. 9C, when the user further pushes the push button 351, the ribs 3514 of the push button 351 presses the motion restriction member 340 in a direction in which the frictional force applied to the interlocking part 320 is reduced, and thus the folding or unfolding operation of the foldable electronic device may be facilitated.

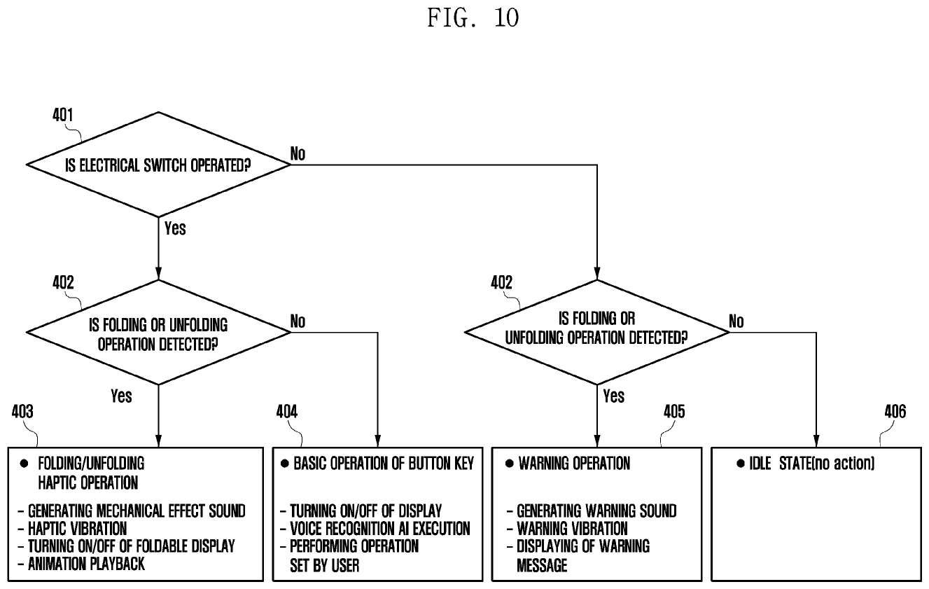

FIG. 10 is a flowchart schematically illustrating operations that may occur based on the manipulation of the button part 350 shown in FIG. 9C of the foldable electronic device.

Referring to FIG. 10, the foldable electronic device may identify whether the electrical switch 354 operates (step 401), may identify whether or not a folding or unfolding operation is performed using the folding sensor 304 when detecting an electrical signal of the electrical switch 354 (step 402), and may perform a folding or unfolding haptic operation when the folding or unfolding operation is performed (step 403).

The folding or unfolding haptic operation (step 403) may be an operation of feeding back to the user a fact that the folding or unfolding operation is performed in the position in which the user pushes the button part 350 via various sensory signals. For example, the folding or unfolding haptic operation (step 403) may include an operation including at least one of effect sound playback, haptic vibration, animation playback, and turning on/off of a display.

The effect sound may be a sound that enhances the user's recognition of the normal folding or unfolding operation of the foldable electronic device and evokes a feeling of comfort, such as a sound that reminds user of the normal operation of a mechanical device. The haptic sound may include, for example, sounds such as a click reminiscent of engagement of a mechanical device, a motor rotation sound and/or a wind noise reminiscent of opening and closing of an automatic door. The haptic vibrations may include low and constant vibrations that remind the user of the normal operation of a mechanical device. The animation may include an image, drawing, or 3D modeling indicating folding or unfolding of the foldable electronic device. In some embodiments, the animation may include various animations that remind the user of a folding or unfolding operation, such as animations depicting flowers blooming and/or sunrise. The turning on/off of the display may include an operation of displaying a standby screen or a lock screen on the display. In some embodiments, when the button part 350 includes a biometric sensor, the operation of turning on of the display may be performed together with the unlocking operation of the foldable electronic device.

Referring back to FIG. 10, the foldable electronic device may identify whether or not the electrical switch 354 is operated (step 401), and when a folding or unfolding operation is detected in the position in which the electrical switch 354 is not operated (step 402), the foldable electronic device may perform a warning operation (step 405). The warning operation (step 405) is an operation of notifying that there is a risk of a problem such as failure or abrasion of the foldable electronic device when the user folds or unfolds the foldable electronic device in the position in which the button part 350 is not manipulated. In some embodiments, the warning operation (step 405) may include operations, such as generation of a warning sound, warning vibration, and/or displaying of a warning message. The warning sound may be a sound that alerts the user or makes the user uncomfortable. The warning sound may include, for example, an effect sound reminiscent of a friction sound of a machine lacking lubrication, a brake operation sound during sudden braking of a vehicle, or a sound of rupture or scratch. Warning vibrations may include vibrations that alert the user and suggest a malfunction of the mechanism, such as strong, short, and repetitive vibrations. The warning message may include a text, a picture, and/or an animation for notifying the user that the button part 350 must be pressed when the foldable electronic device is folded or unfolded.

Referring back to FIG. 10, when only an electrical signal of the electrical switch 354 is detected without a folding or unfolding operation, the foldable electronic device may perform a basic operation (step 404) assigned to the electrical switch 354, such as turning on/off of a display, voice recognition AI execution, or an operation preset by the user. When the user does not operate the electrical switch 354 and also does not perform a folding or unfolding operation, the foldable electronic device may maintain an idle position (step 406) in which the above-described operations are not performed.

When the folding or unfolding operation of the foldable electronic device is performed, the aforementioned folding or unfolding haptic operation (step 404) may also be performed, thereby improving the user experience of the foldable electronic device. In addition, when the user applies an excessive force to the foldable electronic device to fold or unfold the foldable electronic device without manipulating the button part 350, the foldable electronic device performs the warning operation (step 405) for the user so that the risk of damage to the electronic device by the user's mistake can be reduced.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A foldable electronic device comprising:
a foldable enclosure including a plurality of foldable sub-enclosures;
a hinge coupled to ends of the plurality of enclosures to interconnect the sub-enclosures and to allow the foldable enclosure to be folded or unfolded by rotation of the sub-enclosures;
a biaser to apply a rotational force to the hinge in a direction that causes the foldable enclosure to be unfolded;
a follower located inside any one of the sub-enclosures and supported for incremental movement during folding or unfolding of the foldable enclosure;
a stop to selectively come into contact with or be separated from the follower to selectively restrict the movement of the follower; and
an actuator to selectively control folding and unfolding of the foldable electronic device by selectively causing the stop to come into contact with or be separated from the follower.

2. The display apparatus of claim 1, wherein at least one the following applies:
the foldable enclosure comprises a foldable housing and the foldable sub-enclosures comprise foldable sub-housings;
the hinge comprises a hinge part;
the biaser comprises an elastic member;
the follower comprises an interlocking part;
the stop comprises a motion restriction member; and
the actuator comprises a button part.

3. The foldable electronic device of claim 1, wherein the follower comprises a ratchet wheel supported for rotation with the hinge and including a plurality of teeth, and
the stop comprises a ratchet pawl selectively engageable with the teeth of the ratchet wheel.

4. The foldable electronic device of claim 1, wherein the follower comprises a brake rotor supported for rotation with the hinge, and
the stop comprises a brake shoe selectively engageable against the brake rotor to restrict rotation of the brake rotor at an arbitrary rotation angle by friction.

5. The foldable electronic device of claim 4, wherein the brake shoe and the brake rotor are slipped relative to each other when an external force for folding or unfolding the foldable housing is applied in response to the actuator not being actuated, thereby allowing the foldable electronic device to be folded or unfolded.

6. The foldable electronic device of claim 4, wherein the brake rotor has a truncated cone shape, and comprises a brake drum having a first friction surface formed on a side surface of the truncated cone shape, and
the brake shoe comprises a second friction surface having a shape corresponding to the first friction surface.

7. The foldable electronic device of claim 1, wherein the follower comprises a movable member supported for incremental movement relative to the sub-enclosures in response to folding or unfolding of the foldable housing.

8. The foldable electronic device of claim 7, wherein the movable member comprises a sliding member having a rack in which a plurality of teeth are arranged linearly,
the follower further comprises a pinion gear engageable with the rack to rotate incrementally with linear movement of the rack, and a brake rotor supported for rotation by being coupled to the pinion gear, and
the stop comprises a brake shoe selectively engageable against the brake rotor to restrict the rotation of the brake rotor at an arbitrary rotation angle by friction.

9. The foldable electronic device of claim 7, wherein the movable member comprises a sliding friction surface disposed parallel to the direction of linear movement, and
the stop comprises a linear brake to apply a frictional force to the sliding friction surface by being engaged against the sliding friction surface.

10. The foldable electronic device of claim 9, wherein the movable member further comprises a first brake pad attached to the sliding friction surface, and
the stop further comprises a second brake pad attached to a surface of the linear brake facing the sliding friction surface.

11. The foldable electronic device of claim 9, wherein the movable member further comprises a first irregularity formed on the sliding friction surface, and
the stop further comprises a second irregularity formed on a surface of the linear brake facing the sliding friction surface.

12. The foldable electronic device of claim 7, wherein frictional force between the follower and the stop has a relatively large value with respect to a direction in which the moveable member is supported for movement when the foldable enclosure is unfolded, and has a relatively small value with respect a direction in which the moveable member is supported for movement when the foldable enclosure is folded.

13. The foldable electronic device of claim 11, wherein the first irregularity and the second irregularity include asymmetric irregularities that have a relatively steep slope with respect to a direction in which the moveable member is supported for linear movement when the foldable enclosure is unfolded and a relatively gentle slope with respect to a direction in which the moveable member is supported for linear movement when the foldable enclosure is folded.

14. The foldable electronic device of claim 7, wherein the moveable member further comprises a plurality of second sliding friction surfaces opposed to each other, and
the stop further comprises a clamp to apply a frictional force by holding the movable member on the plurality of second sliding friction surfaces.

15. The foldable electronic device of claim 14, further comprising:
a clamp housing including an inner space into which at least a portion of the clamp is inserted,
wherein the clamp includes an inclined surface to be in contact with an inner surface of the inner space of the clamp housing, and
the inclined surface presses the clamp against the second sliding friction surfaces by being moved while being in contact with the inner surface of the inner space of the clamp when the clamp is inserted into the clamp housing.

16. The foldable electronic device of claim 14, wherein the moveable member further comprises an expansion portion in which a thickness of the moveable member is gradually increased,
the clamp further includes a curved portion provided at a distal end facing the expansion portion, and
when the clamp is moved toward the expansion portion, the curved portion is moved along a surface of the expansion portion so that the clamp is spaced apart from the second sliding friction surfaces.

17. The foldable electronic device of claim 1, wherein the actuator comprises an electrical switch disposed thereon to generate an electrical signal when the actuator is operated, and
further comprising:
a sensor to detect the folding or unfolding operation of the foldable housing.

18. A method for operating a foldable electronic device having a foldable enclosure, a hinge to allow the foldable enclosure to be folded, a biaser supported for incremental movement during folding or unfolding of the foldable enclosure, a stop to selectively restrict the movement of the follower, an actuator having an electrical switch to control the folding or unfolding operation, and a sensor to detect the folding or unfolding operation, the method comprising the steps of:
identifying whether or not an electrical signal is generated from the electrical switch;
detecting, by the folding sensor, whether or not the foldable housing is being folded or unfolded; and
when the electrical switch does not generate the electrical signal and the folding sensor detects a folding or unfolding operation, outputting a warning signal including at least one of a warning sound, a warning vibration, or a warning message display.

19. The method of claim 18, further comprising the step of:
when the electrical switch generates the electrical signal and the folding sensor detects folding or unfolding, performing a haptic operation to generate at least one of sound effect playback, haptic vibration, animation playback, and turning-on or off of a display to enhance a user's recognition of the folding or unfolding operation.

20. The method of claim 18, wherein the actuator further comprises a fingerprint recognition sensor to generate a fingerprint identification signal with respect to a selected fingerprint, and
further comprising the step of:
when the electrical switch generates the electrical signal, the folding sensor detects the folding operation, and the fingerprint recognition sensor generates the fingerprint identification signal, unlocking the foldable housing to permit folding
